(19) United States
(12) Patent Application Publication
(10) Pub. No.: US 2017/0325532 A1
(43) Pub. Date: Nov. 16, 2017

(54) ASSEMBLY FOR A CAP WITH AN ILLUMINATED PLASTIC BILL

(71) Applicants: Matthew Gerpheide, San Diego, CA (US); Phuoc N. Nguyen, San Diego, CA (US)

(72) Inventors: Matthew Gerpheide, San Diego, CA (US); Phuoc N. Nguyen, San Diego, CA (US)

(21) Appl. No.: 15/584,304

(22) Filed: May 2, 2017

Related U.S. Application Data
(60) Provisional application No. 62/330,641, filed on May 2, 2016.

(51) Int. Cl. A42B 1/24; H05B 37/02; F21V 33/00; F21V 31/00; F21V 7/22; A42B 1/00; F21S 9/03; A42B 1/06; F21V 9/16; F21Y 2103/10; F21Y 2115/10

(52) U.S. Cl. CPC A42B 1/242; H05B 37/0272; H05B 37/0236; F21V 33/0008; F21V 31/00; F21V 9/16; F21V 7/22; A42B 1/004; F21S 9/037; A42B 1/062; F21Y 2115/10; F21Y 2103/10

(57) ABSTRACT

A cap with an illuminated plastic bill assembly. An illumination assembly provides power and controls for a light source that is used to illuminate the edge or surface of a plastic cap bill. The light passes into and through the plastic cap bill, causing the plastic cap bill to light up and glow in a variety of ways. The plastic bill can also be further decorated in various ways to allow for unique designs to light up and stand out. A cap crown portion provides the foundation to which the illumination assembly and plastic cap bill can be connected to through connection means. All of the listed components combined provides an assembly for a cap with an illuminated plastic bill.

### RELATED APPLICATIONS

This application claims priority to the provisional application with Ser. No. 62/330,641, filed May 2, 2016. The entire contents of the above noted provisional application is incorporated by reference as part of the disclosure of this document.

### FIELD OF THE INVENTION

The present invention generally relates to portable lighting assemblies, and more particularly, to an assembly for a cap with a plastic bill that is illuminated with an illumination assembly.

### BACKGROUND OF THE INVENTION

This section is intended to provide a background or context to the disclosed embodiments that are recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Advances in battery powered lighting have brought about many new possibilities. For example, the small size and low power consumption of current LED arrays has enabled many new applications for portable lighting that were not practical with incandescent light bulbs. Other illumination assembly technologies have also been developed, such electroluminescent and laser powered illumination. These battery powered illumination assemblies can be worn on clothing by persons or animals, can be attached to portable objects, or attached to places or objects where extension cables may be impractical or undesirable.

Thus it would be desirable to provide an assembly for facilitating the lighting of articles of clothing, with an illumination assembly.

### SUMMARY OF CERTAIN EMBODIMENTS

This section is intended to provide a summary of certain exemplary embodiments and is not intended to limit the scope of the embodiments that are disclosed in this application.

One aspect of the disclosed embodiments relates to an illuminated cap assembly comprising an illumination assembly for controlling and powering a light emitting source, a plastic bill with total internal reflective properties allowing light to enter from one surface and exit another with minimum light escaping, a cap crown used to receive the top of a person's head, and connection means for securing the illumination assembly, plastic bill, and cap crown together.

The illumination assembly includes a controller circuit for controlling the operation of a light emitting source. A power supply unit provides electrical power to the light emitting source, wherein the power supply unit includes a battery. One or more control devices provide user control of the controller circuit. Also, an electrical connector provides electrical connections to the external light emitting source. An enclosure provides a housing for the controller circuit and the power supply unit, wherein the enclosure protects components inside from external elements and forces.

Another aspect of the disclosed embodiments relates to an illumination assembly and its connections and interactions with a plastic cap bill. The plastic cap bill provides a transparent or translucent surface that lights up when a light emitting source is positioned along its edge. The light emission source is positioned and attached along the plastic bill edge by various connection means.

Another aspect of the disclosed embodiments relates to plastic cap bill and how it connects the crown part of the cap. The plastic cap bill is positioned and attached to the cap crown portion by various connection means.

An advantage of the present invention is that by adding an illuminated brim to the cap, the user becomes more noticeable. This has the dual benefit of standing out more from a fashion standpoint, as well as a safety standpoint. Additionally, etching, paint, marker ink, patterned sleeves, fabric cutouts, stickers, and other decoration means of the like could be added to the illuminated cap brim to add even more unique character and customization. From a safety standpoint, a user could wear the light up cap to be more noticeable while running or biking or performing many other night time activities. There are also advantages when an illuminated cap is worn by multiple individuals within visual proximity. An illuminated can be group controlled so that patterns and visual effects are coordinated to make the caps light up a certain way and increase their visual effect to the viewership of the surrounding audience.

Additionally, due to advances in technology, there are a variety of sensors, cameras, and communication protocols that can be integrated and used to control the illumination of the cap. The Bluetooth chip used in some control embodiments could react to text messages, phone calls, global positioning systems (GPS) navigation, accelerometer information, and all other broadcasted information over Bluetooth. Additionally, with the evolution of the Internet of Things (IOT), new protocols are being developed and can be used to control and interact with the illumination of a cap. The evolving of smaller and easier to power and conceal sensors and cameras also provides a variety of possibilities with an illuminated cap. For example, sensors can be mounted around the cap and if an object approaches a person at a specified range or speed, the illumination on the cap can flash a specified pattern to give the wearer warning. However sensors any not limited to sensing the environmental conditions and motion of the wearer, but are now able to measure biometrics without skin contact. A useful application would be to notify the illuminated cap wearer that they are dehydrated or their heart rate is too high or their blood sugar is too low.

Additionally, the illumination location does not need to be limited to the plastic bill. In addition with the illuminated plastic bill, other areas around the crown may also illuminate. These additional illumination areas include the front of a cap crown where there are often words or designs and act as the focal point for a cap. The seams of a cap is another good location to include illumination. By adding additional illumination areas to the cap, many of the benefits and advantages of the illuminated cap are magnified and made even more noticeable.

These and other advantages and features of disclosed embodiments, together with the organization and manner of operation thereof, will become apparent from the following detailed description when taken in conjunction with the accompanying drawings.

### BRIEF DESCRIPTION OF THE DRAWINGS

The disclosed embodiments are described by reference to the attached drawings.

FIG. 1 shows a block diagram of a cap with an illuminated plastic bill assembly in accordance with an example embodiment.

FIG. 2 shows a front view of a plastic cap bill in accordance with an example embodiment.

FIG. 3 shows a top view of a plastic cap bill in accordance with an example embodiment.

FIG. 4 shows a front view of a plastic cap bill in accordance with an example embodiment.

FIG. 5 shows a front view of a curved plastic cap bill in accordance with an example embodiment.

FIG. 6 shows an oblique view of a curved plastic cap bill shown in FIG. 5 in accordance with an example embodiment.

FIG. 7 shows a LED assembly in accordance with an example embodiment.

FIG. 8 shows a LED assembly in accordance with an example embodiment.

FIG. 9 shows a LED assembly in accordance with an example embodiment.

FIG. 10 shows a LED assembly in accordance with an example embodiment.

FIG. 11 shows back view of a cap crown in accordance with an example embodiment.

FIG. 12 shows a top view of a cap crown in accordance with an example embodiment.

FIG. 13 shows an oblique view of a cap crown in accordance with an example embodiment.

FIG. 14 shows a plastic cap brim connected to an illumination assembly in accordance with an example embodiment.

FIG. 15 shows a plastic cap brim connected to an illumination assembly in accordance with an example embodiment.

FIG. 16 shows a plastic cap brim connected to an illumination assembly in accordance with an example embodiment.

FIG. 17 shows a side view of a cap with an illuminated plastic bill assembly in accordance with an example embodiment.

FIG. 18 shows a sectional view of a cap with an illuminated plastic bill assembly shown in FIG. 17 in accordance with an example embodiment.

FIG. 19 shows a front view of a cap with an illuminated plastic bill assembly shown in FIG. 17 in accordance with an example embodiment.

FIG. 20 shows an oblique view of a cap with an illuminated plastic bill assembly shown in FIG. 17 in accordance with an example embodiment.

FIG. 21 shows a bottom view of a cap with an illuminated plastic bill assembly shown in FIG. 17 in accordance with an example embodiment.

FIG. 22 shows a top view of a plastic cap bill with an illumination assembly in accordance with an example embodiment.

FIG. 23 shows an oblique view of a plastic cap bill with an illumination assembly in accordance with an example embodiment.

FIG. 24 shows a top view of a plastic cap bill with an illumination assembly in accordance with an example embodiment.

FIG. 25 shows a top view of a plastic cap bill with an illumination assembly in accordance with an example embodiment.

FIG. 26 shows a top view of a plastic cap bill with an illumination assembly in accordance with an example embodiment.

FIG. 27 shows a top view of a plastic cap bill with an illumination assembly in accordance with an example embodiment.

FIG. 28 shows a LED assembly in accordance with an example embodiment.

FIG. 29 shows a top view of a plastic cap bill with an illumination assembly in accordance with an example embodiment.

FIG. 30 shows an illumination assembly control layout in accordance with an example embodiment.

FIG. 31 shows an illumination assembly control layout in accordance with an example embodiment.

FIG. 32 shows an illumination assembly control layout in accordance with an example embodiment.

FIG. 33 shows an illumination assembly control layout in accordance with an example embodiment.

FIG. 34 shows a top view of a plastic cap bill with an illumination assembly in accordance with an example embodiment.

FIG. 35 shows a top view of a plastic cap bill in accordance with an example embodiment.

FIG. 36 shows a top view of a plastic cap bill in accordance with an example embodiment.

FIG. 37 shows a bottom view of a cap crown in accordance with an example embodiment.

FIG. 38 shows a bottom view of a cap crown in accordance with an example embodiment.

FIG. 39 shows a LED assembly in accordance with an example embodiment.

FIG. 40 shows a LED assembly in accordance with an example embodiment.

FIG. 41 shows a LED assembly in accordance with an example embodiment.

FIG. 42 shows a sectional view of a plastic cap bill with an illumination assembly in accordance with an example embodiment.

FIG. 43 shows a sectional view of a plastic cap bill with an illumination assembly in accordance with an example embodiment.

FIG. 44 shows a sectional view of a plastic cap bill with an illumination assembly in accordance with an example embodiment.

FIG. 45 shows a sectional view of a plastic cap bill with an illumination assembly in accordance with an example embodiment.

FIG. 46 shows a top view of a plastic cap bill in accordance with an example embodiment.

FIG. 47 shows a sectional view of a plastic cap bill with an illumination assembly in accordance with an example embodiment.

FIG. 48 shows a top view of a plastic cap bill with an illumination assembly in accordance with an example embodiment.

FIG. 49 shows a sectional view of a plastic cap bill with an illumination assembly in accordance with an example embodiment.

FIG. 50 shows a bottom view of a plastic cap bill with an extension piece in accordance with an example embodiment

FIG. 51 shows a sectional view of a plastic cap bill with an illumination assembly and extension piece in accordance with an example embodiment.

FIG. 52 shows a sectional view of a plastic cap bill with an illumination assembly and extension piece in accordance with an example embodiment.

FIG. 53 shows a sectional view of a plastic cap bill with a cap crown in accordance with an example embodiment.

FIG. 54 shows a sectional view of a plastic cap bill with a cap crown in accordance with an example embodiment.

FIG. 55 shows a sectional view of a plastic cap bill with a cap crown in accordance with an example embodiment.

FIG. 56 shows a sectional view of a plastic cap bill with a cap crown in accordance with an example embodiment.

FIG. 57 shows a sectional view of a plastic cap bill with a cap crown in accordance with an example embodiment.

FIG. 58 shows a sectional view of a plastic cap bill with a cap crown and sweatband in accordance with an example embodiment.

FIG. 59 shows a sectional view of a plastic cap bill with a cap crown and sweatband in accordance with an example embodiment.

FIG. 60 shows a sectional view of a plastic cap bill with a cap crown and sweatband in accordance with an example embodiment.

FIG. 61 shows a top view of a plastic cap bill in accordance with an example embodiment.

FIG. 62 shows a top view of a plastic cap bill in accordance with an example embodiment.

FIG. 63 shows a sectional view of a plastic cap bill in FIG. 62 in accordance with an example embodiment.

FIG. 64 shows a sectional view of a plastic cap bill in accordance with an example embodiment.

FIG. 65 shows a top view of a plastic cap bill in accordance with an example embodiment.

FIG. 66 shows a top view of a plastic cap bill in accordance with an example embodiment.

FIG. 67 shows a top view of a plastic cap bill in accordance with an example embodiment.

FIG. 68 shows a top view of a plastic cap bill in accordance with an example embodiment.

FIG. 69 shows a front edge view of a plastic cap bill in accordance with an example embodiment.

FIG. 70 shows a top view of a plastic cap bill in accordance with an example embodiment.

FIG. 71 shows a front view of an alternative plastic cap bill in accordance with an example embodiment.

FIG. 72 shows a sectional view of the fitted cap crown attached to a plastic cap bill by connections means in accordance with an example embodiment.

FIG. 73 shows a front view of an alternative plastic cap bill in accordance with an example embodiment.

FIG. 74 shows a top view of an illumination assembly in accordance with an example embodiment.

FIG. 75 shows a sectional view of the positioning of the top layer and bottom layer from FIG. 73 and the base, top layer of light emitting components, and bottom layer of light emitting components from FIG. 74 in accordance with an example embodiment.

### DETAILED DESCRIPTION OF CERTAIN EMBODIMENTS

In the following description, for purposes of description and not limitation, details and descriptions are set forth in order to provide a thorough understanding of the disclosed embodiments. However, it will be apparent to those skilled in the art that the present invention may be practiced in other embodiments that depart from these details and descriptions.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

There is a need for illumination assemblies that can be used in clothing and other apparel. There are many articles of clothing that can be enhanced to stand out more and made to look more stylish and unique by adding bright vibrant illumination to them. More specifically, there is a lack of cap assemblies that utilize illumination technology. Consumers and businesses are continually looking to stand out more and more in today's world. The best way to do that is to utilize items that draw in attention and are eye catching. Caps for instance, are the highest sitting article of clothing on a person, which makes it the easiest thing to see on a person in a moderate to heavily crowed public spaces. If you were to wear a cap emitting bright light, you would become much more noticeable and visible. Additionally, in situations of low lightning or nighttime activities, it is much harder for a person to be seen. With an illuminated cap a person would stand out greatly in these conditions and would be much more noticeable and safe in darker environments. The industries of illumination assemblies and clothing are very different, and thus, integrating the two would be very challenging. Thus it would be desirable to bring clothing products to market that have illumination assemblies integrated into them and solve the problems of assembly and the requirement of understanding illumination technology.

Additionally, there is great potential to be able to light up a group of people and be able to control the light that those people are wearing. Light up caps could be outfitted with lights that have the ability to be controlled wirelessly from a distance and interact with other light up caps or other light up wearable technology so that an entire crowd at a sports game could become one big visual display. With the addition of a wide variety of sensors, such as accelerometers or motion sensors, wears would be able to generate cool visual effects such as the popular “wave” celebration at festivals, sports gatherings, and other events.

FIG. 1 shows a block diagram of a cap with an illuminated plastic bill assembly 10 in accordance with an example embodiment. A plastic cap bill 12 is connected to part of an illumination assembly 14, by a connection means 18. The plastic cap bill 12 is also attached to a cap crown 16 by connection means 20. Part of the illumination assembly 14 is attached to the cap crown 16 by connection means 22. The plastic cap bill 12 may comprise of a clear acrylic sheet laser cut into the shape of a typical cap bill. The illumination assembly 14 may comprise a shortened version of LED assembly model No. RFT-3V-SMD3528-24D-1P68 from the online store name Lmid Official Store. Additionally the illumination assembly 14 may comprise a thin electroluminescent strip similar to Ellumiglow's Slimmest Rectangular EL Panel. The illumination assembly may comprise of laser power assembly such as Corning's Fibrance Light-Diffusing Fiber.

The three main parts of the cap with an illuminated plastic bill assembly 10, plastic cap bill 12, illumination assembly 14, cap crown 16, are connected by connection means 18, 20, 22. These connection means 18, 20, 22, may each comprise one or more of connection techniques including: being sewn together, taped together, glued or adhered together, connected by hook and loop fasteners, mounted or connected via plastic mechanical fasteners, screws, button snaps, magnets, rivets, zippers, or connection means of the like.

The purpose of the illumination assembly 14, is to provide a bright light source that projects into and through the plastic cap bill 12, so that the plastic cap bill edge, graphics, and designs on the plastic cap bill 12, and/or partial areas or the entirety of the plastic cap bill 12, will illuminate. The plastic cap bill 12 is configured so that light enters at one edge and remains inside of the bill due to total internal reflectance until it is scattered and becomes visible at the edge or at another area along the surface of the bill. The illumination assembly 14 may have the ability to produce light of constant color or light that changes color and pattern along the edge or surface at which it illuminates.

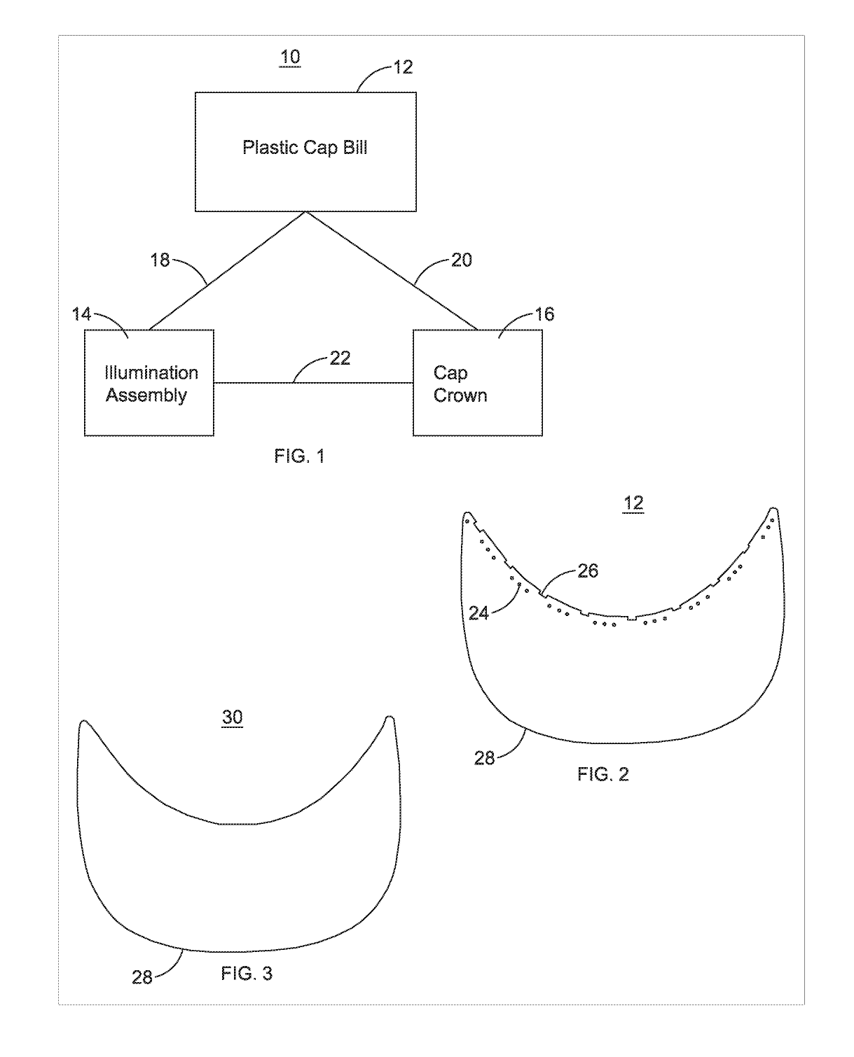

FIG. 2 shows a top view of the plastic cap bill 12 in accordance with an example embodiment. The plastic cap bill 12 has notches 26 to facilitate the positioning of an illumination assembly 14. The plastic cap bill 12 has holes 24 facilitate sewing. The plastic cap bill edge 28 is labeled for reference.

FIG. 3 shows a top view of the plastic cap bill 30 in accordance with an example embodiment. This cap bill assembly does not have notches 26 and holes 24 as shown in cap bill 12 shown in FIG. 2. The benefit of cap bill 30 not including notches 26 and holes 24 is reduced manufacturing cost and a smooth edge is sufficient for other types of illumination assemblies and connection means other than sewing. The plastic cap bill edge 28 is labeled for reference.

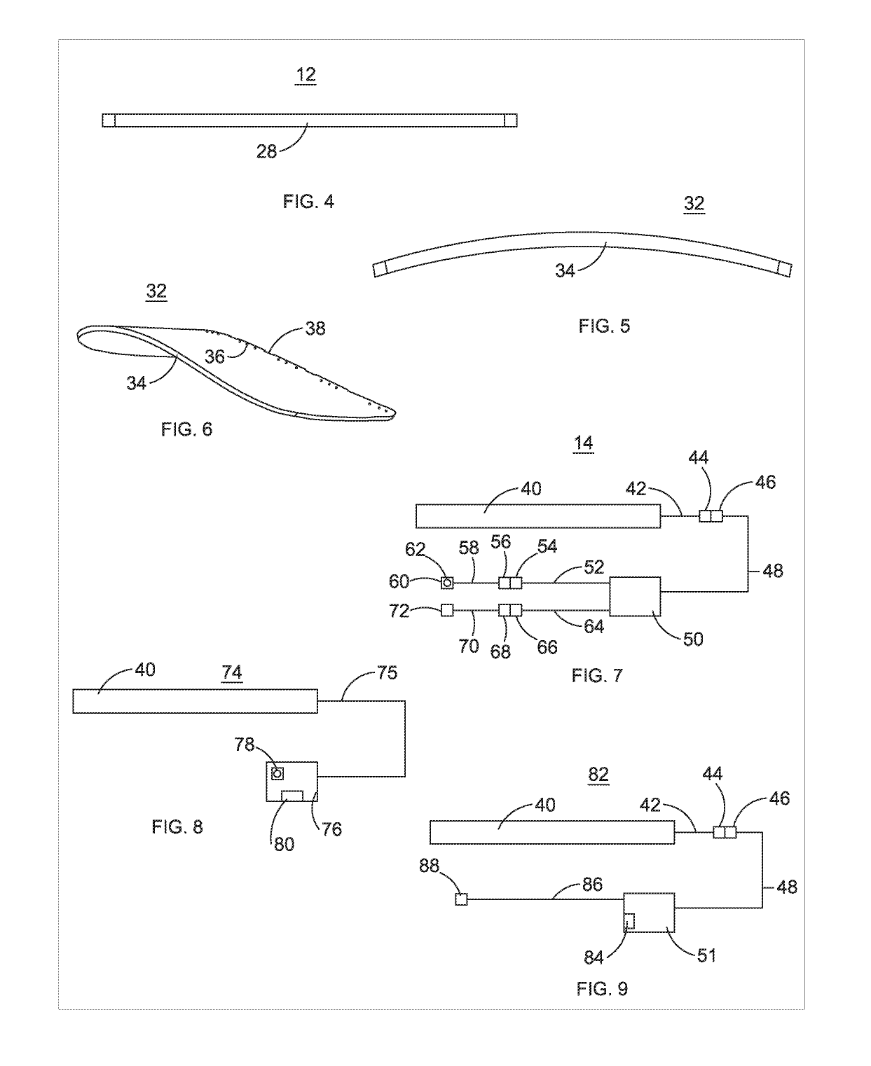

FIG. 4 shows a front view of the plastic cap bill 12 shown in FIG. 2 in accordance with an example embodiment, from which the plastic cap bill edge 28 can be seen.

FIG. 5 shows a front view of a curved plastic cap bill 32 in accordance with an example embodiment, from which the curved edge 34 of the plastic cap bill 32 can be seen. The benefit of the plastic cap bill 32 including a curved edge 34 is to provide a different visual lighting effect, style look, and cap fit.

FIG. 6 shows an oblique view of the curved plastic cap bill 32 shown in FIG. 5 in accordance with an example embodiment, from which the curved edge 34 of the curved plastic cap bill 32 can be seen. The curved plastic cap bill 32 has notches 38 to facilitate the positioning of a LED strip. The curved plastic bill has holes 36 cut in to facilitate connection means of sewing.

FIG. 7 shows the illumination assembly 14 in accordance with an example embodiment. In this embodiment the illumination assembly 14 consists of a LED assembly. A LED strip 40 is connected by wires 42 to a connector 44. Connector 44 is connected to a receiving connector 46 that uses wires 48 to connect to a battery and controller module 50. The battery and controller module 50 has wires 52 connected to a connector 54 that is connected to a receiving connector 56. Connector 56 is connected to wires 58 which connects to housing 60 for a push button 62. The battery and controller module 50 has wires 64 connected to a connector 66 that is connected to a receiving connector 68. Connector 68 is connected to wires 70 which connects a charging port 72.

The LED strip 40 is controlled by the battery and control module 50. The battery and control module 50 sends necessary information through the wires 42, 48 and connectors 44, 46 so that the LED strip 40 can respond in accordance to a user's commands. The LED strip 40 may comprise Shenzhen Lstronic Industry CO., LTD 3528 SMD single color LED strip, 3528 SMD RGB LED strip, 3528 Surface Mount Device (SMD) RGB individually addressable LED Strip, 5050 SMD single color LED strip, 5050 SMD RGB LED strip, 5050 SMD RGB individually addressable LED Strip, or similar LED arrays or strips.

A user's command are able to be sent by pressing the push button 62 and to cycle through the programmed modes on the battery and control module 50. This is done by sending the push button 62 press information through wires 64, 70 and connectors 66, 68 to the battery and control module 50.

The battery and control module 50 includes a portable power source for the LED strip 40 and the controller board that is included in the battery and control module 50. The batteries inside the battery and control module 50 may comprise lithium ion batteries, coin cell batteries, button cell batteries, A123 batteries, AA batteries, AAA, batteries, 9 volt batteries, or other rechargeable and non-rechargeable batteries of the like. The control board part of the battery and control module 50 may comprise of a circuit board that is controlled by button presses, Bluetooth or Bluetooth low energy signal, infrared (IR) signal, Wi-Fi signal, radio frequency (RF) signal, touch sensitive screen, switches, dials, wireless communication protocols related to IOT, or wirelessly broadcasted signal and switch mechanisms of the like. For further details of control boards which may be adapted for use with the present embodiments see U.S. 2015/0345717 and U.S. 2016/0223149, which are incorporated herein by reference.

The charging port 72 allows for convenient and easy charging of the battery and control module 50. The charging port 72 may comprise micro USB port, USB type c port, USB A port, USB B port, lightening cable port, or other charging ports of the like.

FIG. 8 shows an alternative illumination assembly 74 in accordance with an example embodiment. A LED strip 40 is connected by wires 75 to a battery and controller module 76. A push button 78 and charging port 80 are integrated into the battery controller module 76 to provide convenient and compact positioning for ease of use and concealment.

The benefit to illumination assembly 74 shown in FIG. 8 over LED assembly 14 shown in FIG. 7 is that it is more compact and facilitates concealment.

FIG. 9 shows an alternative illumination assembly 82 in accordance with an example embodiment. An LED strip 40 is connected by wires 42 to a connector 44. Connector 44 is connected to a receiving connector 46 that uses wires 48 to connect to a battery and controller module 51. A charging port 84 is integrated into the battery and controller module 51. The battery and controller module 51 has wires 86 connected to an IR receiver 88. The IR receiver 88 allows for control of the LED light strip 40 with commands sent by the user with an IR transmitter.

The benefit to illumination assembly 82 shown in FIG. 9 is that it allows the IR receiver 88 to be placed conveniently and effectively for best line of sight. Additionally, by just having wires 86 as a connection, concealment of the illumination assembly 82 is facilitated.

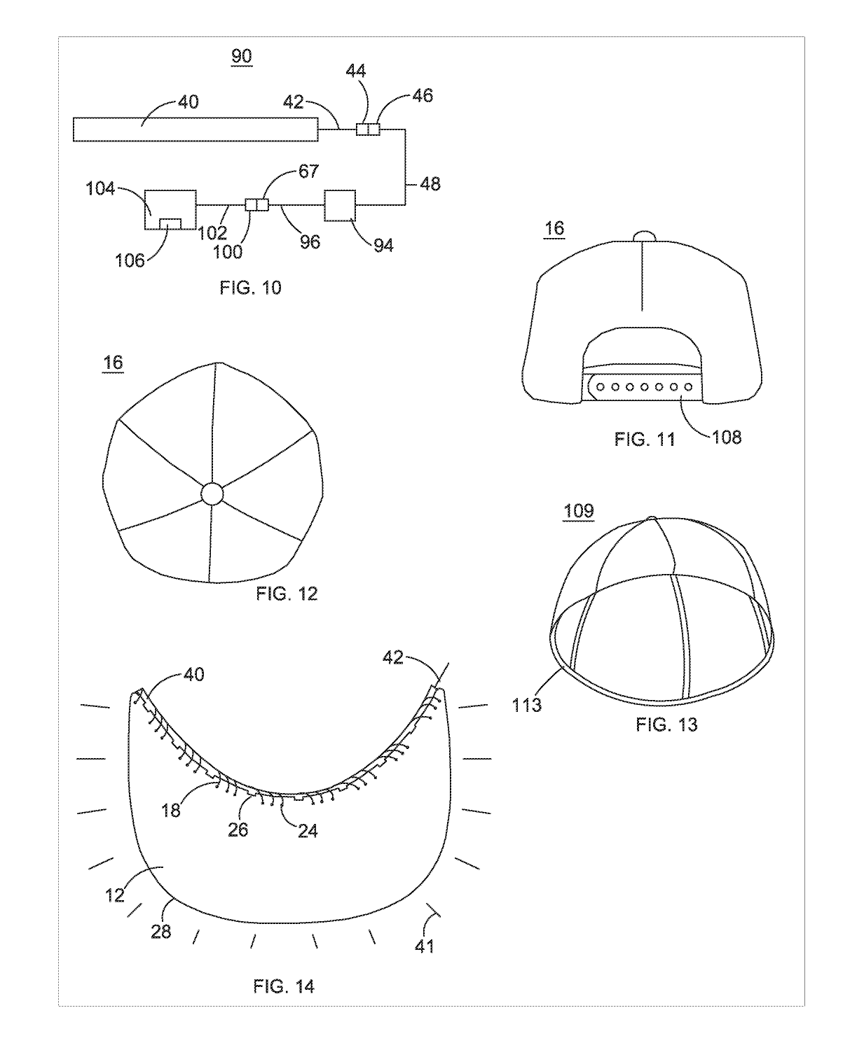

FIG. 10 shows an alternative illumination assembly 90 in accordance with an example embodiment. An LED strip 40 is connected by wires 42 to a connector 44. Connector 44 is connected to a receiving connector 46 that uses wires 48 to connect to a Bluetooth low energy controller circuit board 94. The Bluetooth low energy controller circuit board 94 has wires 96 connected to a connector 98 that is connected to a receiving connector 100. Connector 100 is connected to wires 102 which connects to a battery power source with charging circuit 104. A charging port 106 is integrated into the battery power source with charging circuit 104.

The Bluetooth low energy controller circuit board 94 provides the ability to control the LEDs wirelessly via Bluetooth low energy signal. This enables the illumination assembly 90 the ability to communicate with smart wearable devices, computers, cellular phones, and other Bluetooth compatible electronics. The control of the LEDs would be executed through an App or similar program that provides a visual interface for the user to interact with. The Bluetooth low energy controller circuit board 94 may comprise Adafruit Feather 32u4 Bluefruit LE.

FIG. 11 shows a back view of the cap crown 16 in accordance with an example embodiment, from which the adjustable sizing 108 of the cap crown 16 can be seen. The adjustable sizing 108 may comprise different styles such as snapback, hook and loop fasteners, strap and buckle, elastic band, and other commonly used mechanisms to provide sizing adjustability to a cap.

FIG. 12 shows a top view of the cap crown 16 in accordance with an example embodiment.

FIG. 13 shows an oblique view of a fitted cap crown 109 in accordance with an example embodiment, from which the interior cap crown fold 113 can be seen. By creating and interior cap crown fold 113, this helps facilitate the assembly procedure for specific assemble methods. Additionally, the fitted cap crown 109 is made with a range of sizing is an alternative to providing an adjustable sizing 108 and is commonly used in the hat and cap industry.

FIG. 14 shows a top view of a LED strip 40 attached to a plastic cap bill 12 by connection means 18 in accordance with an example embodiment. The plastic cap bill 12 has notches 26 and holes 24. The holes 24 facilitate the attachment of the LED strip 40 and plastic cap bill 12 with connection means 18. Connection means may comprise sewing with thread, string, wire, or other materials of the like. Light 41 is emitted along the plastic cap bill edge 28, visually making the plastic cap bill edge 28 glow. In particular, light from the LED strip 40 enters the plastic cap bill 12 at the edge on one side and, due to total internal reflection, remains inside the bill until it reaches the edge 28 where it is emitted and scattered from the edge. This causes the edge 28 to glow, while the rest of the bill remains transparent. Plastic cap bill edge 28 may comprise an optically transparent surface for more direct and strong light 41 output or, in other embodiments, may comprise an optically transparent surface that is frosted or diffused to provide more even and soft light 41 output.

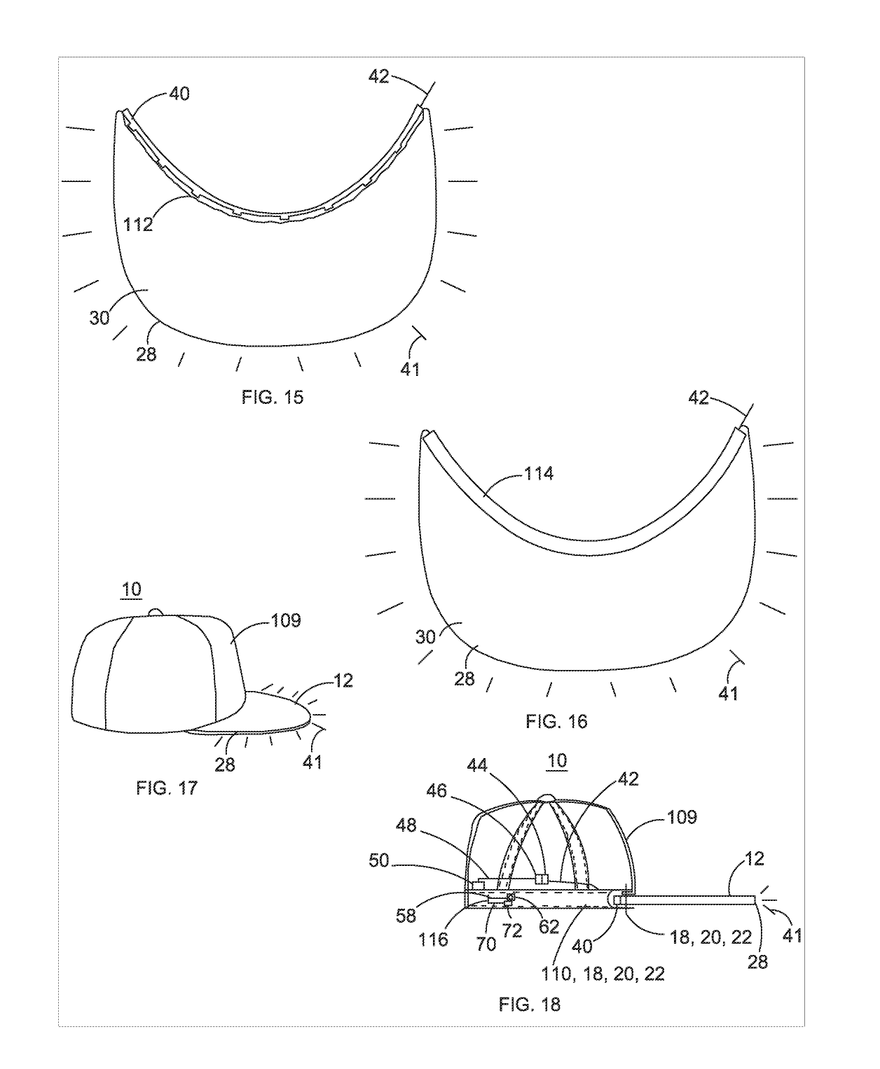

FIG. 15 shows a top view of a LED strip 40 attached to an alternative plastic cap bill 30 by connection means 112 in accordance with an example embodiment. The plastic cap bill edge 28 allows light 41 to be emitted. Connection means 112 may comprise glue, tape, adhesive, epoxy, or materials of the like. The benefit of the connection means 112, in comparison to connection means 18 from FIG. 14, is that it provides an alternative means to connect the LED strip 40 to a plastic cap bill 30 and may facilitate assembly during manufacturing, improved durability, and product functionality.

FIG. 16 shows a top view of a plastic cap bill 30 and an LED strip 40 concealed by connection means 114 in accordance with an example embodiment. The connection means 114 covers the LED strip 40 and presses it against the plastic cap bill 30. The plastic cap bill edge 28 allows light 41 to be emitted. The benefit of the connection means 114, in comparison to connection means 18 in FIG. 14, is that it provides an alternative means to connect the LED strip 40 to a plastic cap bill 30 and may facilitate assembly during manufacturing and could connect within seconds, requiring less time to assemble. Additionally, connection means 114 allows for the easy and quick removal of the enclosed LED assembly 14. Connection means 114 may comprise various materials, such as plastic, rubber, metal, fiber reinforce polymers, fabric, hook and loop fasteners, or other materials that can be made or cut into the necessary shape.

FIG. 17 shows a side view of a cap with an illuminated plastic bill 10 in accordance with an example embodiment, from which the plastic cap bill 12 and the cap crown 109 of the cap with an illuminated plastic bill 10 can be seen. The plastic cap bill edge 28 allows light 41 to be emitted.

FIG. 18 shows a sectional view of the cap with an illuminated plastic cap bill 10 as shown in FIG. 17 in accordance with an example embodiment. The plastic cap bill 12, LED strip 40, and cap crown 16 are all sewn together by connection means 18, 20, 22. The sweat band 110, acts as connection means 18, 20, 22, by encasing the plastic cap bill 12, LED strip 40, and cap crown 109. The sweat band 110, also acts as connection means 22 by helping to contain parts of the LED assembly 14 including wires 42, 48, 58, 70, unseen connectors 56, 58, 66, 68, and battery and control module 50. An opening 116 in the sweat band 110 allows for wires 58, 70 and charging port 72 and push button 62 to be exposed for ease of use. The plastic cap bill edge 28 allows light 41 to be emitted.

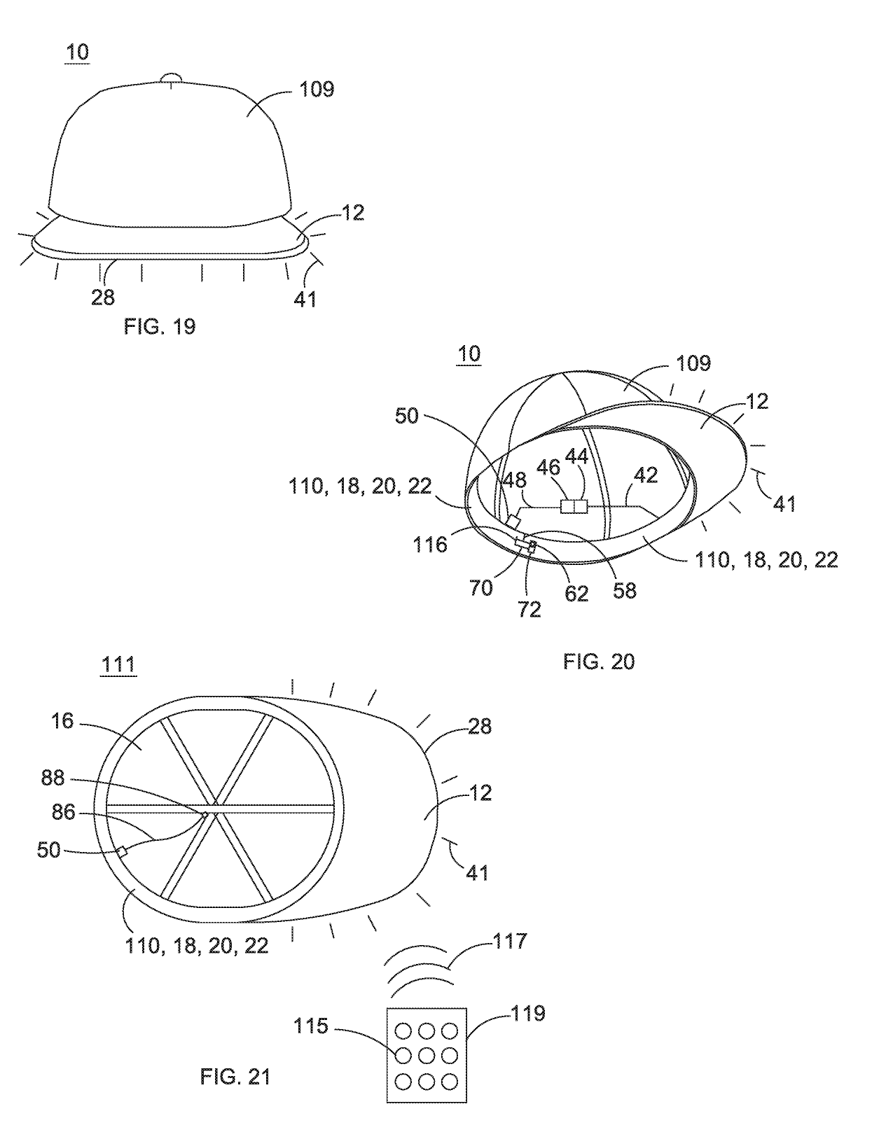

FIG. 19 shows a front view of the cap with an illuminated plastic bill 10 as shown in FIG. 17 in accordance with an example embodiment, from which the plastic cap bill 12 and the cap crown 109 of the cap with an illuminated plastic bill 10 can be seen. The plastic cap bill edge 28 allows light 41 to be emitted.

FIG. 20 shows an oblique view of the cap with an illuminated plastic bill 10 as shown in FIG. 17 in accordance with an example embodiment. The sweat band 110, acts as connection means 18, 20, 22, by connecting the plastic cap bill 12, LED strip 40, and cap crown 109. The sweat band 110 also acts as connection means 22 by helping to contain parts of the LED assembly 14 including wires 42, 48, 58, 70, unseen connectors 56, 58, 66, 68, and battery and control module 50. An opening 116 in the sweat band 110 allows for wires 58, 70 and charging port 72 and push button 62 to be exposed for ease of use. The plastic cap bill edge 28 allows light 41 to be emitted.

FIG. 21 shows a bottom view of a cap with an illuminated plastic bill 111 in accordance with an example embodiment. The sweat band 110, acts as connection means 18, 20, 22 by helping to conceal, contain, and connect the plastic cap bill 12, the LED assembly 14, and cap crown 109. An IR receiver 88 is placed near the top portion of the cap crown 109 to provide maximum visibility to receive an IR signal 117 emitted from an IR transmitting remote 119 with button controls 115. The IR receiver 88 connects to wires 86 that runs along the cap crown 109 to the battery control module 50. The IR transmitting remote 119 may comprise typical 44 key and 24 key IR remotes for SMD 3528 and SMD 5050 LED strips. The plastic cap bill edge 28 allows light 41 to be emitted.

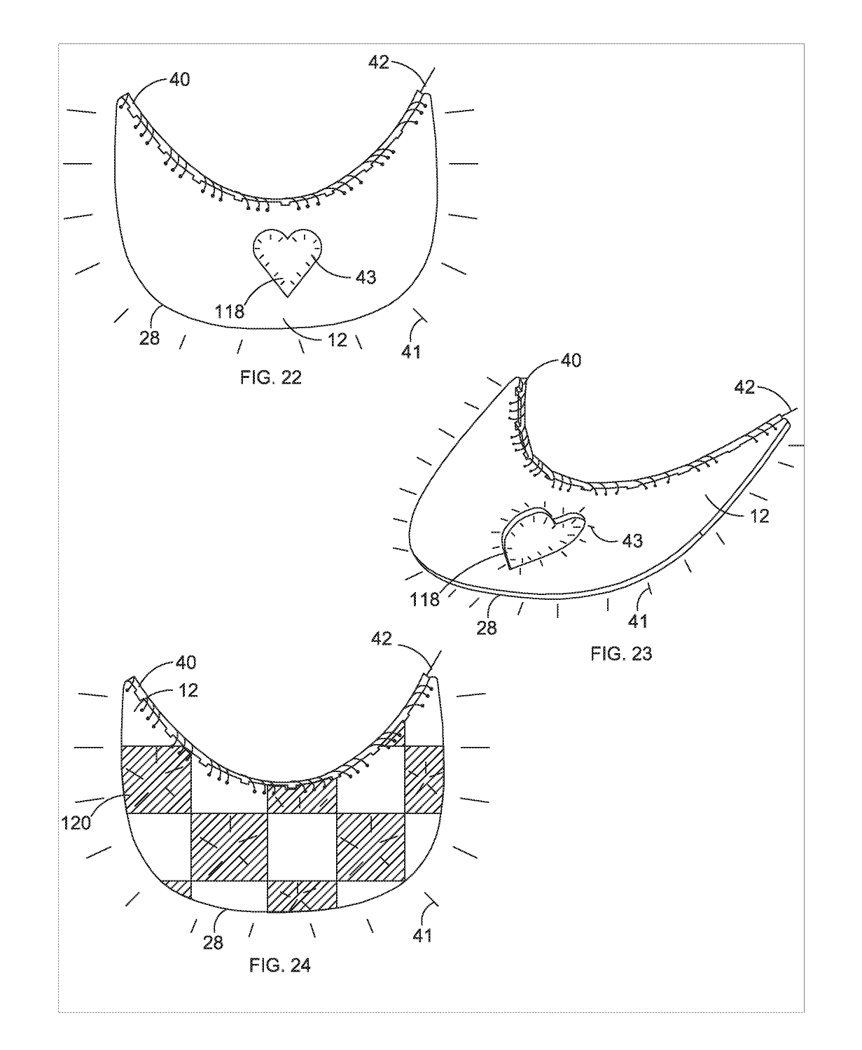

FIG. 22 shows a top view of a plastic cap bill 12 in accordance with an example embodiment. A LED strip 40 is attached to a plastic cap bill 30 by connection mean 18 to provide lighting into the plastic cap bill 30. A decorative design 118 is cut out of the plastic cap bill 12 to provide an interior edge 43 to create an additional lightening effect of the decorative design 118. In particular, the interior edge 43 scatters light in a similar manner as the edge 28, so that light escapes the bill and becomes visible. The plastic cap bill edge 28 allows light 41 to be emitted.

FIG. 23 shows an oblique view of a plastic cap bill 12 as shown in FIG. 22 in accordance with an example embodiment, from which the decorative design 118, interior edge 43 creating an additional lightening effect, and plastic cap bill edge 28 light 41, can be seen.

FIG. 24 shows a top view of a plastic cap bill 12 in accordance with an example embodiment. A LED strip 40 is attached to a plastic cap bill 12 by connection means 18 to provide lighting into the plastic cap bill 30. A decorative design 120 is painted or screen printed onto one or both sides of the plastic cap bill 12 to provide a unique lighting effect 45 in which light is transmitted or reflected in the shape of the decorative design 120. In particular, the decorative design 120 allows light to escape from the bill and to become scattered and visible in the desired pattern. The plastic cap bill edge 28 allows light 41 to be emitted.

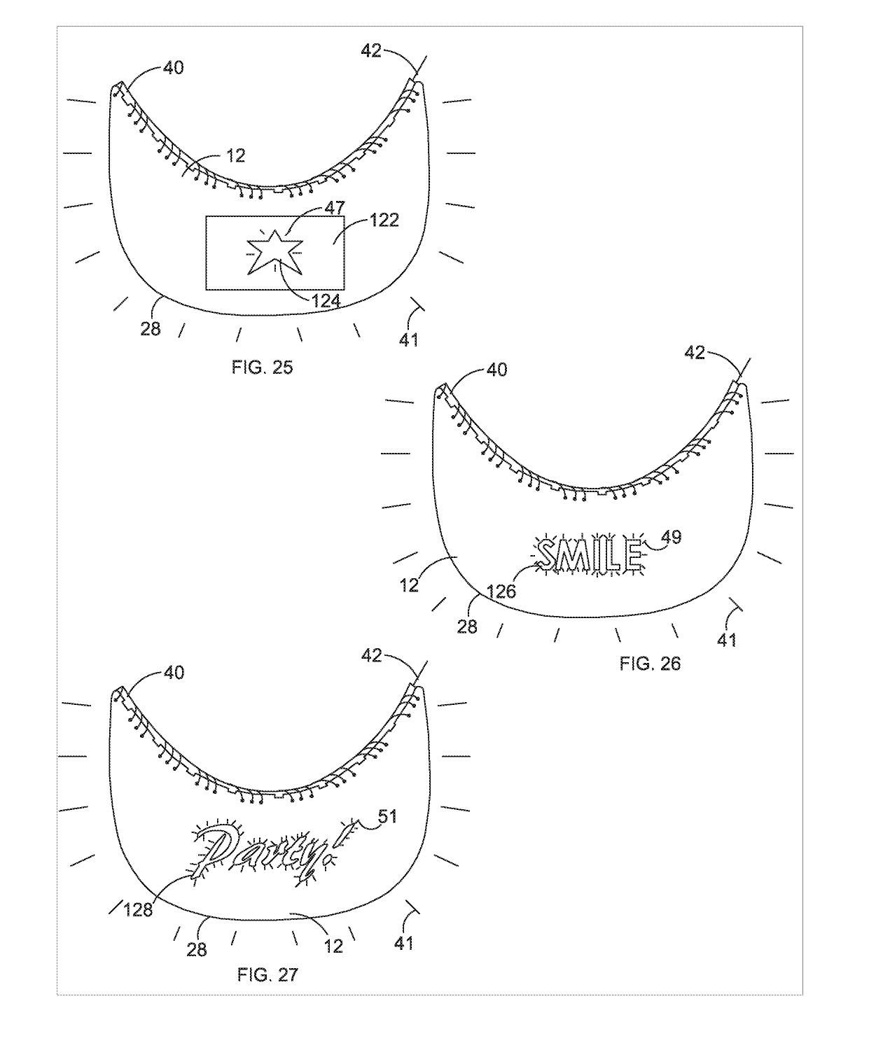

FIG. 25 shows a top view of a plastic cap bill 12 in accordance with an example embodiment. A LED strip 40 is attached to a plastic cap bill 30 by connection means 18 to provide lighting into the plastic cap bill 30. A decorative design 124 is printed onto a sticker 122 which can be designed to be permanently attached or removable from the plastic cap bill 12 to provide a unique lighting effect 47 of the decorative design 124. The sticker may comprise a clear or colored static cling vinyl, adhesive backed, or other stickers of the like. In particular, the decorative design 124 allows light to escape from the bill and to become scattered and visible in the desired pattern. The plastic cap bill 12 edge 28 allows light 41 to be emitted.

FIG. 26 shows a top view of a plastic cap bill 12 in accordance with an example embodiment. A LED strip 40 is attached to a plastic cap bill 30 by connection means 18 to provide lighting into the plastic cap bill 30. A decorative design 126 is etched, computer numerical control (CNC) routed, engraved, or sanded onto the plastic cap bill 12 to provide a unique lighting effect 49 of the decorative design 126. In particular, the decorative design 126 allows light to escape from the bill and to become scattered and visible in the desired pattern. The plastic cap bill edge 28 allows light 41 to be emitted.

FIG. 27 shows a top view of a plastic cap bill 30 in accordance with an example embodiment. A LED strip 40 is attached to a plastic cap bill 30 by connection means 18 to provide lighting into the plastic cap bill 30. A decorative design 128 is written or drawn on in marker onto one or both sides of the plastic cap bill 12 to provide a unique lighting effect 51 of the decorative design 128. The marker may comprise liquid chalk florescent neon markers and dry erase markers. In particular, the decorative design 128 allows light to escape from the bill and to become scattered and visible in the desired pattern. The plastic cap bill edge 28 allows light 41 to be emitted.

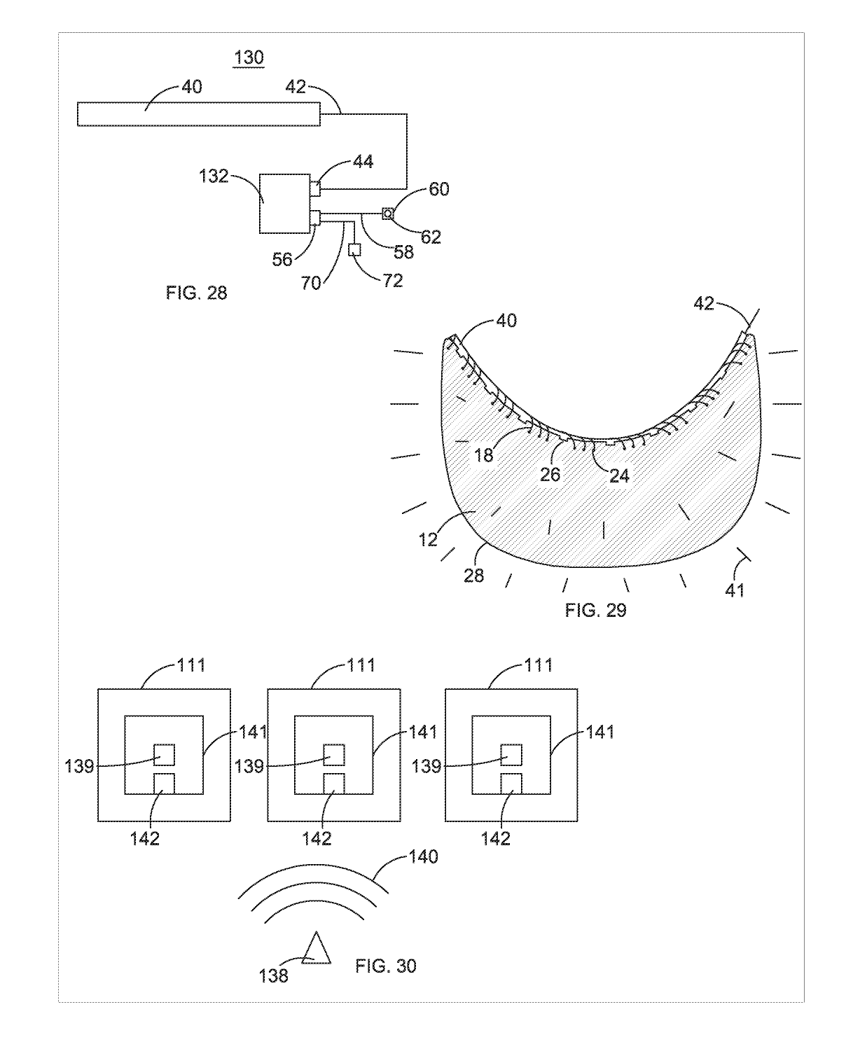

FIG. 28 shows an alternative illumination assembly 130 in accordance with an example embodiment. A LED strip 40 is connected by wires 42 to a connector 44. The connector 44 plugs into a battery and controller module 132. A push button 62 is enclosed by housing 60, which connects to wires 58. Wires 58 connects to a connector 56. A charging port 72 is connected to wires 70. Wires 70 is also connected to connector 56. Connector 56 plugs into the battery and control module 132. The benefit in including connection point on the battery and control module, is that it reduces connection points, may allow for shorter wire lengths during manufacturing production, and allows the LED assembly 130 to be more compact while having the added ability to remove and swap the battery and control module 132 from the LED assembly 130.

FIG. 29 shows a top view of an alternative plastic cap bill 134 in accordance with an example embodiment. A LED strip 40 is attached to a plastic cap bill 30 by connection mean 18 to provide lighting into the plastic cap bill 30. The plastic cap bill 134 is made with a translucent material, instead of transparent, that allows the plastic cap bill 134 to have a unique evenly distributed glow effect 136 over the entire surface in addition to the plastic cap bill edge 28 lighting 41.

FIG. 30 shows a layout depicting a group of caps with an illuminated plastic bill 111 in accordance with an example embodiment. The caps with an illuminated plastic bill 111 are made with a LED assembly 141 that includes IR receivers 139 and IR transmitters 142. The LED assembly 141 included in the caps with an illuminated plastic bill 114 are controlled via IR transmission signals 140 that are emitted from an IR transmission source 138. The LED assembly 141 inside the caps with an illuminated plastic bill 111 may comprise similar technology to the Mickey Mouse Glow with the Show Light Up Ear Hat. The LED assembly 141 inside the caps with an illuminated plastic bill 111 may comprise similar technology to Pixmob's Ignite Pro and Video LED interactive devices. The IR transmitter 142 may comprise similar technology to Pixmob's Infrared wash lights. For further details of ways to illuminate groups of hats see U.S. Oat. No. 9, 286,028 which is hereby incorporated by reference.

FIG. 31 shows a layout depicting a group of caps with an illuminated plastic bill 144 in accordance with an example embodiment. The caps with an illuminated plastic bill 144 are made with a LED assembly 143 with a Bluetooth receivers 145. The LED assembly 143 included in the caps with an illuminated plastic bill 144 are controlled via Bluetooth transmissions signals 150 that are emitted from a Bluetooth compatible device 146. The Bluetooth compatible device 146 can be controlled with a program or application (App) 148. The Bluetooth compatible device 146 may comprise a cell phone with Android software of Lollipop 5.0 or higher with Bluetooth broadcast advertising packet capabilities or with Apple software with iBeacon Technology.

The App 148 provides the user access with several ways to control the LED assembly 143 inside the caps with an illuminated plastic bill 144. The App 148 may include control of one or more of the following: color, pattern, brightness, response to set clock times or timers, response to movement, response to external sound, response to sound playing from phone or App 148 device, response to notifications, response to Global Positioning Systems (GPS) and location, response to ambient temperature, response to ambient light intensity, response to temperature sensors, electrocardiogram sensors, object proximity sensors and cameras, motion sensors, and other sensors of the like.

The App 148 communicates to the LED assembly 143 through Bluetooth or Bluetooth Low Energy (BLE) pairing and BLE broadcasting advertising packets. BLE pairing allows the App 148 to connect directly to the LED assembly 143 and establish a connection that will be recognized for future use. This allows the user to setup a secure connection that is protected from outside strangers from connecting to the user's LED assembly 143. Up to eight LED assemblies 143 can be accessed and controlled via BLE pairing. However, only 1 device can be controlled at a time, resulting in user commands to be sent out one after the other. This can be done very fast with current technology, but there may be visually noticeable delay from the control of device 1 to device 8.

The App 148 with BLE broadcasting advertising packets technology is able to control any LED assembly 143 within broadcasting range and appropriate broadcasting ID. With BLE broadcasting advertising packets, LED control commands authorized through the App 148 are broadcasted over a specific designated broadcasting ID. The broadcasting ID can be assigned to an LED assembly 143 through the App 148 by setting it up utilizing BLE pairing. Once the LED assembly 143 is assigned a broadcasting ID, it can be controlled by the App 148 by broadcasting advertising packets with the same broadcasting ID that was set up. If this broadcasting ID is assigned to multiple LED assemblies 143, then the multiple LED assemblies 143 can all be controlled from one broadcasting device 146 through the App 148 if within the broadcasting range. This allows the caps with an illuminated plastic bill 144 to be group controlled using Bluetooth transmission signals 150.

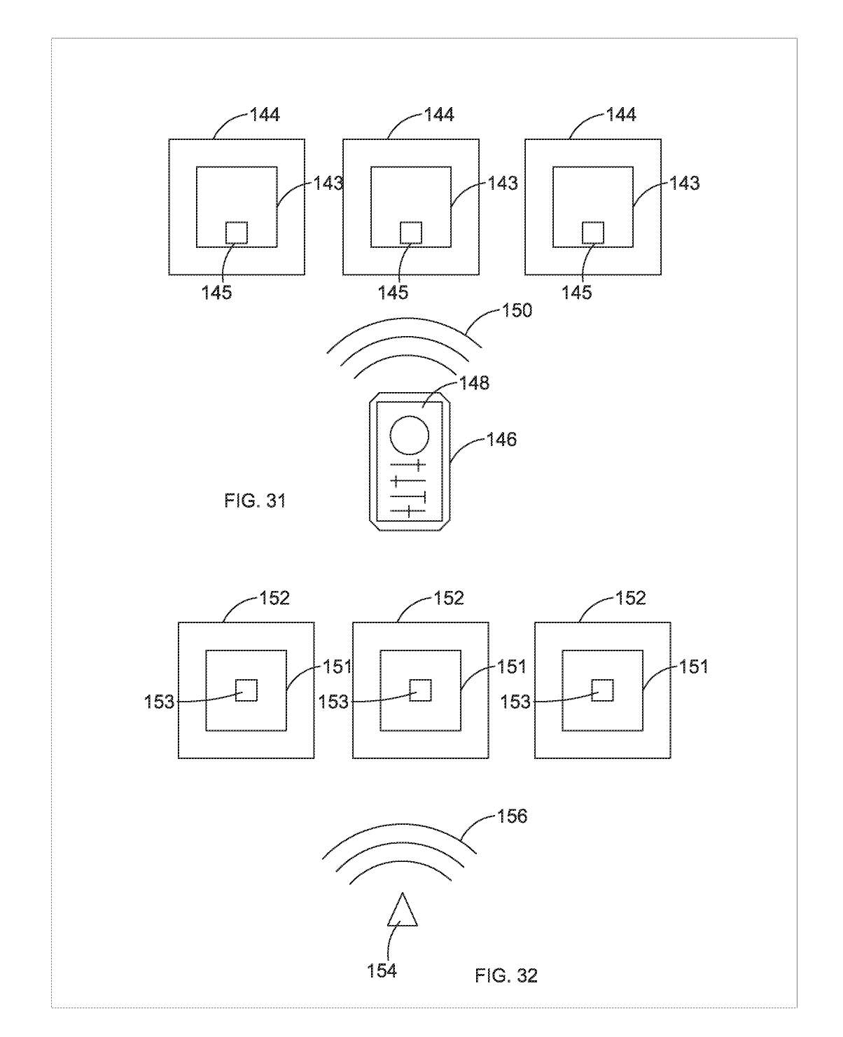

FIG. 32 shows a layout depicting a group of caps with an illuminated plastic bill 152 in accordance with an example embodiment. The cap with an illuminated plastic bill 152 are made with a LED assembly 151 that includes RF receivers 153. The LED assembly 151 included in the caps with an illuminated plastic bill 152 are controlled via RF transmission signals 156 that are emitted from an RF transmission source 154. The LED assembly 154 inside the caps with an illuminated plastic bill 152 may comprise similar technology to the Glow Motion Technology Beach Balls and Wrist Bands. The RF transmitter 154 may comprise similar technology to Glow Motion Technology Transmitters. For further details see U.S. patent application no. U.S. 2015/0179029, which is incorporated hereby by reference.

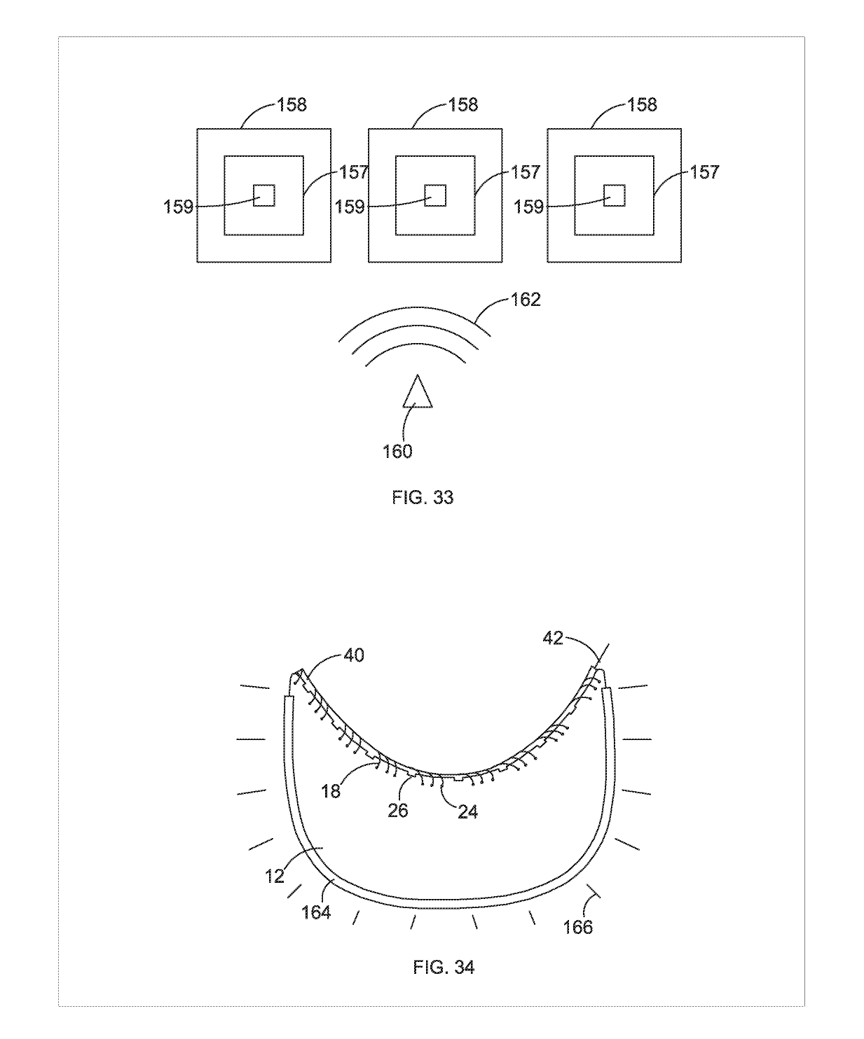

FIG. 33 shows a layout depicting a group of caps with an illuminated plastic bill 158 in accordance with an example embodiment. The cap with an illuminated plastic bill 158 are made with a LED assembly 157 that includes Bluetooth receivers 159. The LED assembly 157 included in the caps with an illuminated plastic bill 158 are controlled via Bluetooth transmission signals 162 that are emitted from a Bluetooth transmission source 160. The LED assembly 157 inside the caps with an illuminated plastic bill 158 may comprise similar technology to the Pixmob Spark+Wrist Bands. The LED assembly 157 inside the caps with an illuminated plastic bill 158 may comprise similar technology to the Pixmob Spark Wrist Bands with the Spark App. The Bluetooth transmitter 160 may comprise similar technology to Pixmob's Bluetooth Broadcaster and Repeater with Amplified Bluetooth signal.

FIG. 34 shows a top view of a plastic cap bill 12 in accordance with an example embodiment. A LED strip 40 is attached to a plastic cap bill 12 by connection means 18 to provide lighting into the plastic cap bill 12. An edge sleeve 164 is fitted onto the plastic cap bill 12 to provide a unique lighting effect 166 in which light is diffused and scattered in more directions or redirected in different patterns an angles or is changed color by the color of the edge sleeve 164.

FIG. 35 shows a top view of a plastic cap bill 12 in accordance with an example embodiment. A LED strip 40 is attached to a plastic cap bill 12 by connection means 18 to provide lighting into the plastic cap bill 12. A decorative design 170 is laser cut a fraction of the way through the plastic cap bill 12 to provide a unique lighting effect 168 of the decorative design 170. In particular, the decorative design 170 allows light to escape from the bill and to become scattered and visible in the desired pattern. The plastic cap bill edge 28 allows light 41 to be emitted.

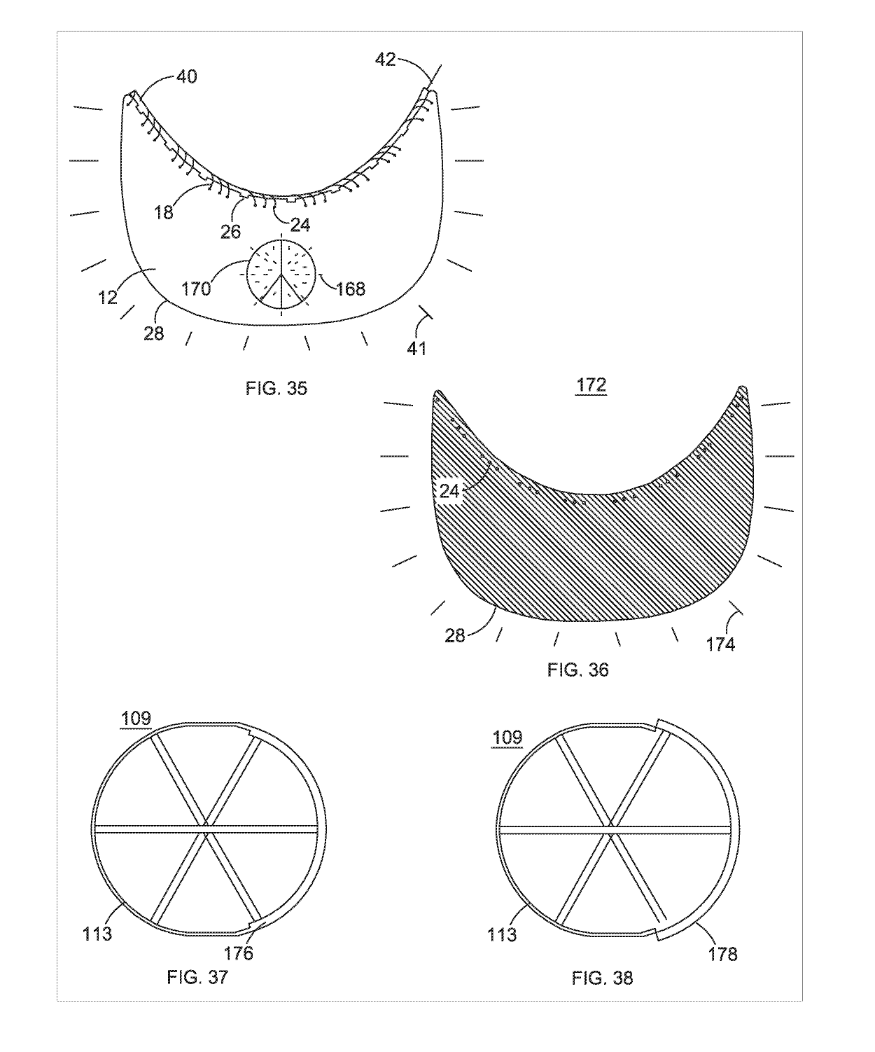

FIG. 36 shows a top view of a plastic cap bill 172 in accordance with an example embodiment. The plastic cap bill 172 consists of florescent acrylic that does not require a battery powered light source to produce a glowing edge 174. The glowing edge 174 is produced by ambient ultraviolet (UV) light that is captured by the plastic cap bill 172 and redirected to the edges of the acrylic to produce a glowing edge 174. This allows the cap assembly to have similar visual effects to acrylic with edge mounted LEDs, but without requiring the LED light source. The plastic cap bill 172 made of florescent acrylic, would be most beneficial in areas or rooms with black lighting or UV lighting, and enhanced by low amounts of light outside of the UV electromagnetic spectrum.

FIG. 37 shows a bottom view of a fitted cap crown 109 in accordance with an example embodiment, from which the interior cap crown fold 113 and modified interior cap crown fold 178 can be seen. By allowing the modified interior cap crown fold 176 to lay flat along the front portion of the cap crown 109, it creates a large surface for connection means 20 to connect the cap crown 109 to the plastic hat bill 12.

FIG. 38 shows a bottom view of a fitted cap crown 109 in accordance with an example embodiment, from which the interior cap crown fold 113 and modified interior cap crown fold 178 can be seen. By allowing the modified interior cap crown fold 178 to lay flat, on the exterior, along the front portion of the cap crown 109, it creates a large surface for connection means 20 to connect the cap crown 109 to the plastic hat bill 12.

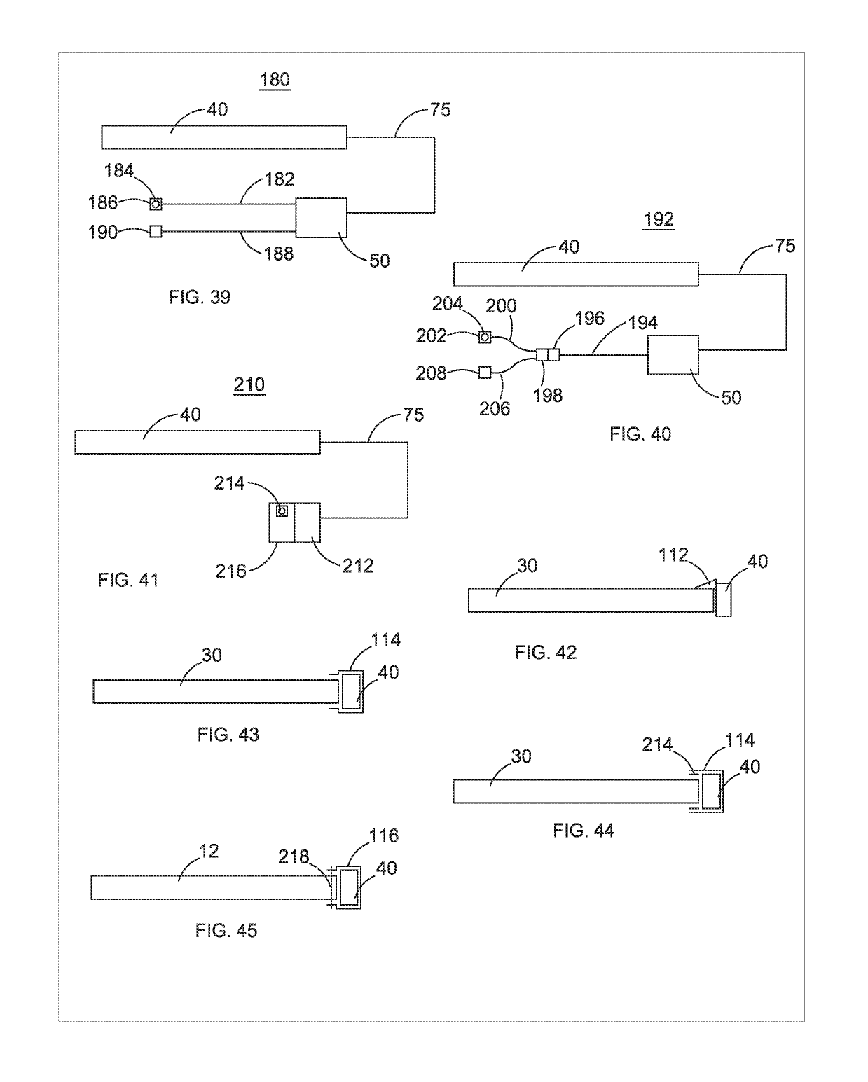

FIG. 39 shows an alternative illumination assembly 180 in accordance with an example embodiment. A LED strip 40 is connected by wires 75 a battery and controller module 50. The battery and controller module 50 has wires 182 connected to housing 186 for a push button 188. The battery and controller module 50 has wires 188 connected to a charging port 190.

The benefit of not including connectors on wires 75, 182,188, is that there are less wire end points and less likelihood of mechanical failure of wires 75, 183, 188 at points of connection. This makes for a more durable LED assembly 14.

FIG. 40 shows an alternative LED assembly 192 in accordance with an example embodiment. A LED strip 40 is connected by wires 75 to a battery and controller module 50. The battery and controller module 50 has wires 194 connected to a connector 196 that is connected to a receiving connector 198. Connector 198 is connected to wires 200 which connects to housing 202 for a push button 204. Connector 198 is connected to wires 206 which connects a charging port 208.

The benefit of including connectors 196, 198 between wires 200, 206 and wires 194 is provide an easy way to unplug the button 204 from the battery and controller module 50 and prevent an accidental activation of the LED assembly 192 during actions such as shipping and transportation.

FIG. 41 shows an alternative illumination assembly 210 in accordance with an example embodiment. A LED strip 40 is connected by wires 75 to a battery and controller module 216. A push button 214 is integrated into the battery controller module 216. An access panel 212 provides access to a battery compartment which allows the user to replace the batteries.

FIG. 42 shows a sectional view of a LED strip 40 attached to an alternative plastic cap bill 30 by connection means 112 as shown in FIG. 15 in accordance with an example embodiment.

FIG. 43 shows a sectional view of a LED strip 40 attached to an alternative plastic cap bill 30 by connection means 114 as shown in FIG. 16 in accordance with an example embodiment.

FIG. 44 shows a sectional view of a LED strip 40 attached to an alternative plastic cap bill 30 by connection means 114 and connection means 214 as shown in FIG. 16 in accordance with an example embodiment. Connection means 214 may comprise of glue, adhesive, tape, hook and loop fasteners, magnets or other connection means of the like.

FIG. 45 shows a sectional view of a LED strip 40 attached to a plastic cap bill 12 by connection means 216 and connection means 218 in accordance with an example embodiment. Connection means 216 is similar to connection means 114, however connection means 216 contains access openings for connection means 218 to pass through. Connection means 218 may comprise rivets, thread, plastic rod, button snaps, or other connection means of the like.

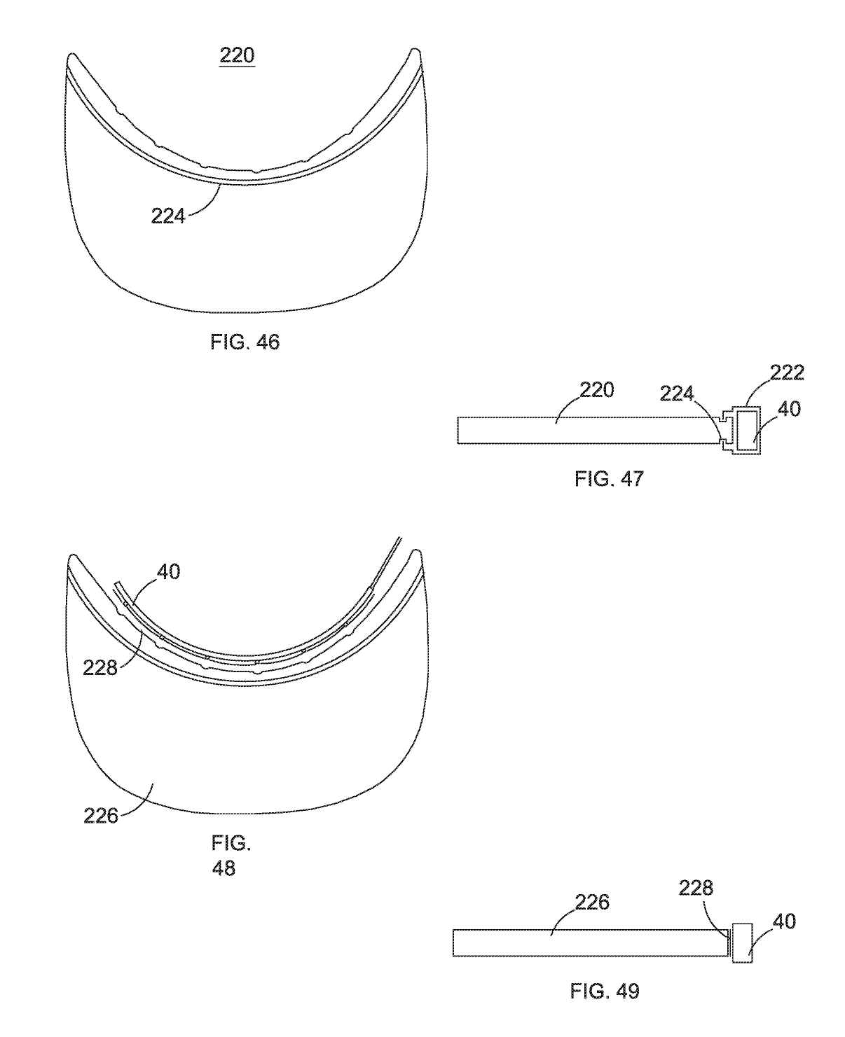

FIG. 46 shows a top view of an alternative plastic cap bill 220 in accordance with an example embodiment. The plastic cap bill 220 has a notch 224 to facilitate connections means.

FIG. 47 shows a sectional view of a LED strip 40 attached to an alternative plastic cap bill 220 by a notch 224 and connection means 222 in accordance with an example embodiment. Connection means 222 is similar to connection means 114, however connection means 222 is shaped to fit into notch 224. Notch 224 may be continuous or segmented and may recess partially or completely through the plastic cap bill 220.

FIG. 48 shows a top view of an alternative plastic cap bill 226 in accordance with an example embodiment. The plastic cap bill 226 has connection means 228, which is used to attach the LED strip 40 to plastic cap bill 226. Connection means 228 may comprise adhesive, tape, glue, or connection means of the like.

FIG. 49 shows a sectional view of the LED strip 40 attached by connection means 228 to an alternative plastic cap bill 226 in FIG. 28 in accordance with an example embodiment.

FIG. 50 shows a bottom view of an alternative plastic cap bill 30 in accordance with an example embodiment. An extension piece 230 is attached to the bottom of the alternative plastic cap bill 30 to provide a facilitated connection surface for further assembly steps and provide an aesthetic cover to conceal lighting component. Notches 232 are cut into the extension piece 230 to provide facilitate workability of extension piece 230 when folded at 90 degrees. The extension piece 230 may comprise fabric, hook and loop fastener, plastic, leather, metal, wood, or other connection means of the like.

FIG. 51 shows a sectional view of the extension piece 230 attached by connection means 234 to the alternative plastic cap bill 30 in FIG. 50 in accordance with an example embodiment. Connection means 234 may comprise adhesive, tape, glue, or connection means of the like.

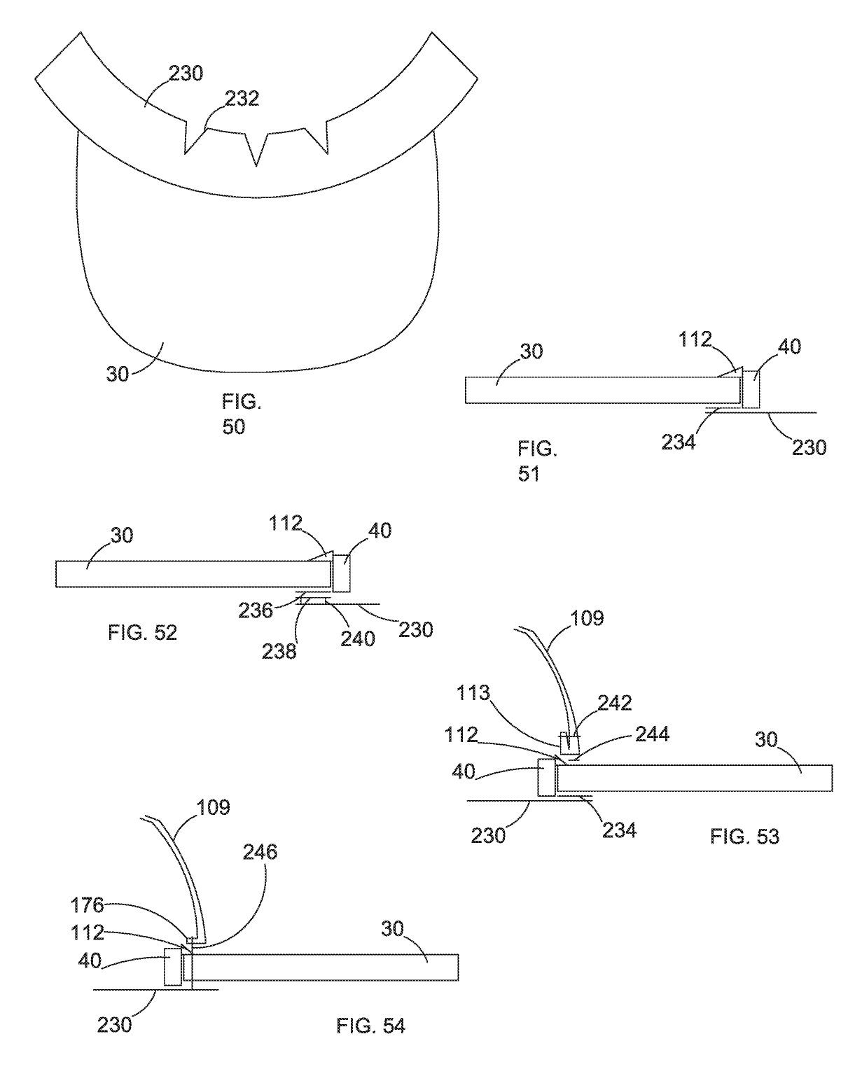

FIG. 52 shows a sectional view of the extension piece 230 attached by connection means 236, connection means 238, and LED strip 40 to an alternative plastic cap bill 30 in accordance with an example embodiment. Connection means 236 may comprise of hook and loops fasteners, magnets, or other materials of the like with adhesive, tape, or glue backing. Connection means 238 may comprise hook and loop fasteners, magnets, or other connection means of the like. Connection means 240 is used to connect connection means 238 to extension piece 230. Connection means 240 may comprise sewing, adhesive, tape, glue, or other connection means of the like.

FIG. 53 shows a sectional view of the fitted cap crown 109 attached to alternative plastic cap bill 30 by connections means 244 in accordance with an example embodiment. The interior cap crown fold 113 is held in place by connection means 242. Connection means 242 may comprise sewing, staples, plastic fasteners, rivets, magnets, hook and loop fasteners, adhesive, tape, glue, buttons, zippers, or other connection means of the like. Connection means 244 allows fitted cap crown 109 to be connected to alternative plastic cap bill 30. Connection means 244 may comprise adhesive, tape, glue, or other connection means of the like.

FIG. 54 shows a sectional view of the fitted cap crown 109 attached to alternative plastic cap bill 30 by connections means 246 in accordance with an example embodiment. The interior cap crown fold 176 is position flat against alternative plastic cap bill 30 to facilitate connection mean 246. Connections means 246 may also provide connection between extension piece 230 and alternative plastic cap bill 30. Connection means 246 may comprise sewing, rivets, plastic fasteners, buttons, screws, and other connection means of the like.

FIG. 55 shows a sectional view of the fitted cap crown 109 attached to alternative plastic cap bill 30 by connections means 248, connection means 250, and connection means 252 in accordance with an example embodiment. The modified interior cap crown fold 178 is positioned flat against alternative plastic cap bill 30 to facilitate connection means 248, connection means 250, and connection means 252. Connection means 248 may comprise hook and loops fasteners, magnets, or other connections of the like with adhesive, tape, or glue backing. Connection means 250 may comprise hook and loop fasteners, magnets, or other connection means of the like. Connection means 252 is used to connect connection means 250 to the fitted cap crown 109. Connection means 252 may comprise sewing, adhesive, tape, glue, or other connection means of the like.

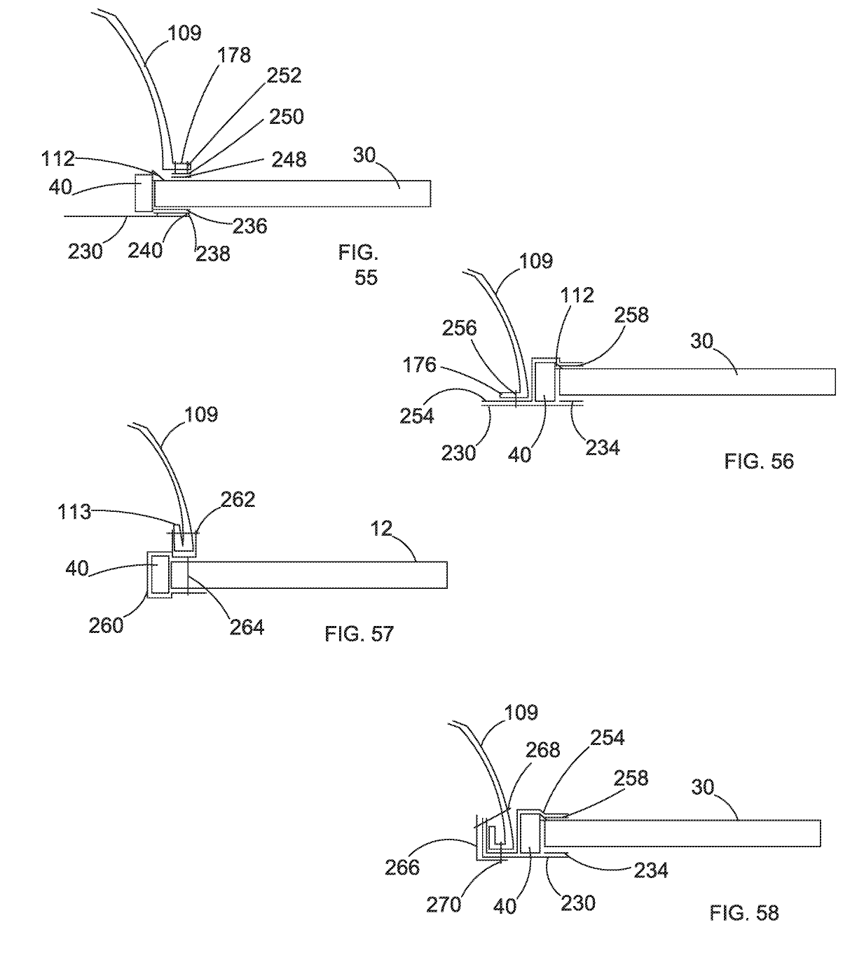

FIG. 56 shows a sectional view of the fitted cap crown 109 attached to top extension piece 254 by connections means 256, in accordance with an example embodiment. The interior cap crown fold 176 is positioned flat against to top extension piece 254 to facilitate connection means 256. Connection means 256 may comprise sewing, rivets, plastic connectors, adhesive, tape, glue, or other connection means of the like. The top extension piece 254 wraps around LED strip 40 and may also attach to the top of the alternative plastic cap bill 30 by connections means 258. The top extension piece 254 may comprise fabric, hook and loop fastener, plastic, leather, metal, wood, or other connection means of the like. Connection means 258 may comprise adhesive, tape, glue, or other connection means of the like.

FIG. 57 shows a sectional view of the fitted cap crown 109 attached to a plastic cap bill 12 by connections means 260 and connection means 262, in accordance with an example embodiment. The interior cap crown fold 113 is positioned inside of connection means 260 and is connected to connection means 260 by connection means 262. Connection means 260 may comprise plastic casing, metal casing, or other connection means of the like. Connection means 262 may comprise screws, rivets, plastic connectors, sewing, or other connection means of the like. Connection means 260 may also connect to plastic cap bill 12 by connection means 264. Connection means 264 may comprise screws, rivets, plastic connectors, sewing, pins, or other connection means of the like.

FIG. 58 shows a sectional view of the fitted cap crown 109 attached to a plastic cap bill 12 by connections means 234, connection means, 254, connection means 268, and connection means 270, in accordance with an example embodiment. The fitted cap crown 209 is attached to the top extension piece 254, extension piece 230, and sweatband 266 by connection means 268 and connection means 270. Connection means 268 and connections means 270 may comprise sewing, rivets, plastic connectors, pins, or other connection means of the like.

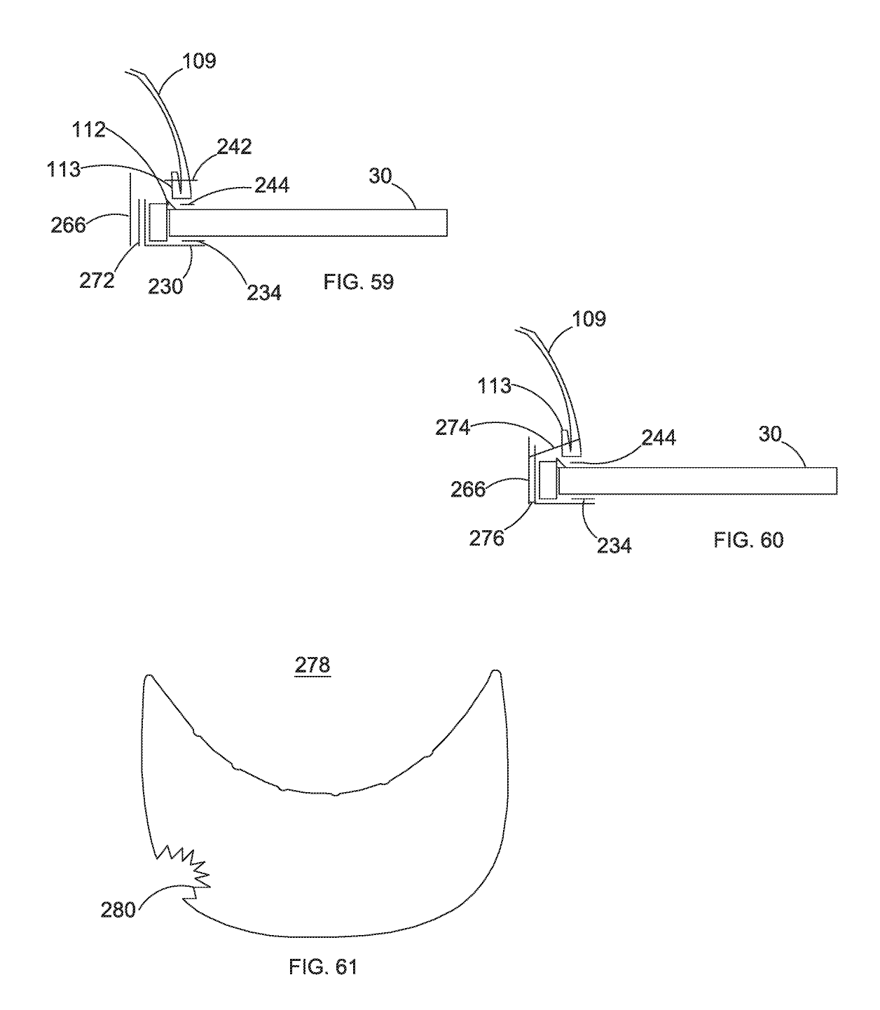

FIG. 59 shows a sectional view of the fitted cap crown 109 attached to an alternative plastic cap bill 30, in accordance with an example embodiment. The sweatband 266 is attached to the extension fabric by connection means 272. Connection means 272 may comprise adhesive, tape, glue, or other connection means of the like.

FIG. 60 shows a sectional view of the fitted cap crown 109 attached to an alternative plastic cap bill 30, in accordance with an example embodiment. The sweatband 266 is attached to the extension fabric by connection means 274 and connection means 276. Connection means 274 and connection means 276 may comprise sewing, rivets, plastic connectors, pins, or other connection means of the like.

FIG. 61 shows a top view of an alternative plastic cap bill 278 in accordance with an example embodiment. A decorative design is created by bill cut out 280 on the plastic cap bill 278. The bill cut out 280 provides a unique aesthetic look to the plastic bill 278.

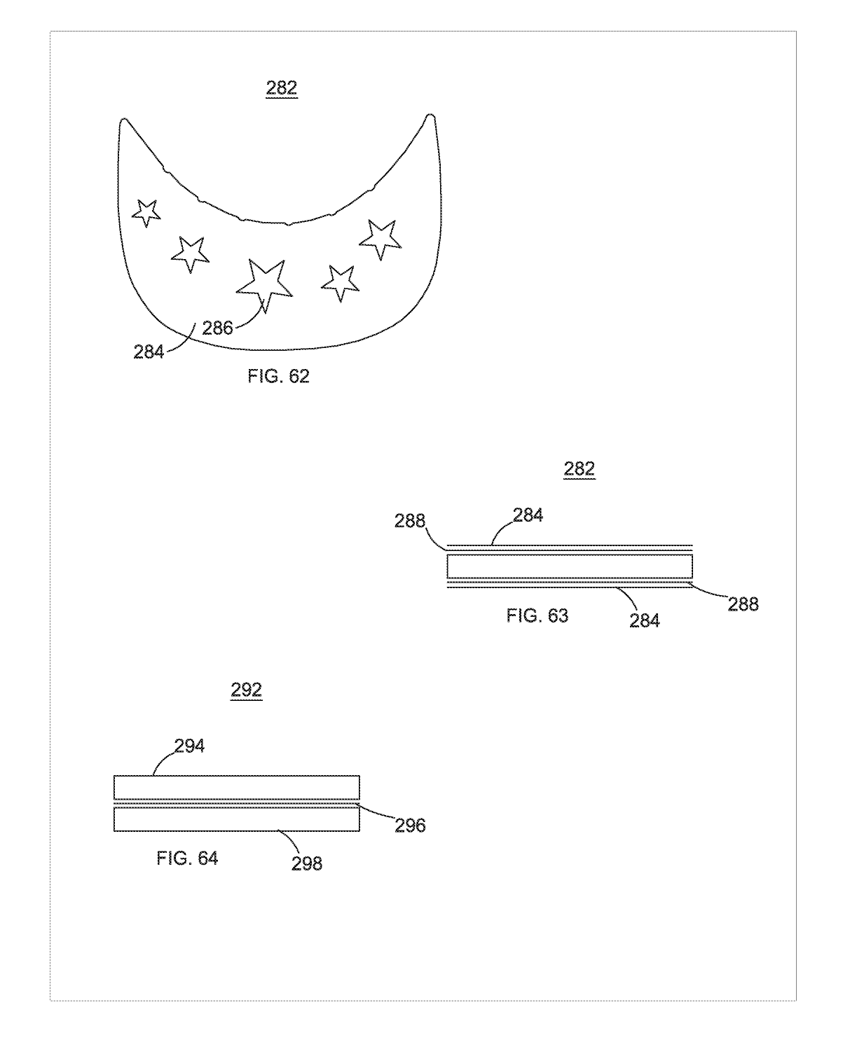

FIG. 62 shows a top view of an alternative plastic cap bill 282 in accordance with an example embodiment. A decorative design is made by placing design material 284 onto the plastic cap bill 282 and creating an etched design 286 through the design material. The design material may consist of different colors and opacities. The design material 284 is used to make the etched design 286 stand out and provide further aesthetic to the caps and potentially add addition light protection from sources such as the sun. The etched design 286 is to provide a path for the illumination to escape where desired. The design material may comprise of plastic, fabric, metal, wood, or other material of the like.

FIG. 63 shows a sectional view of an alternative plastic cap bill 282 in accordance with an examples embodiment. Design material 284 is attached to the top and bottom of an alternative plastic cap bill 282 through connection means 288. Connection means 288 may comprise of adhesive, tape, glue, or other connection means of the like.

FIG. 64 shows a sectional view of an alternative plastic cap bill 292 in accordance with an examples embodiment. An illuminated sheet 296 is place between a top sheet of plastic 294 and a bottom sheet of plastic 298 to form the alternative plastic cap bill 292. The illuminated sheet 296 emits light in the vertical direction, allowing illumination to be visible through the top sheet of plastic 294 and bottom sheet of plastic 298. The illuminated sheet may consist of electroluminescent materials, thin edge lit plastic, or other lighting sources of the like.

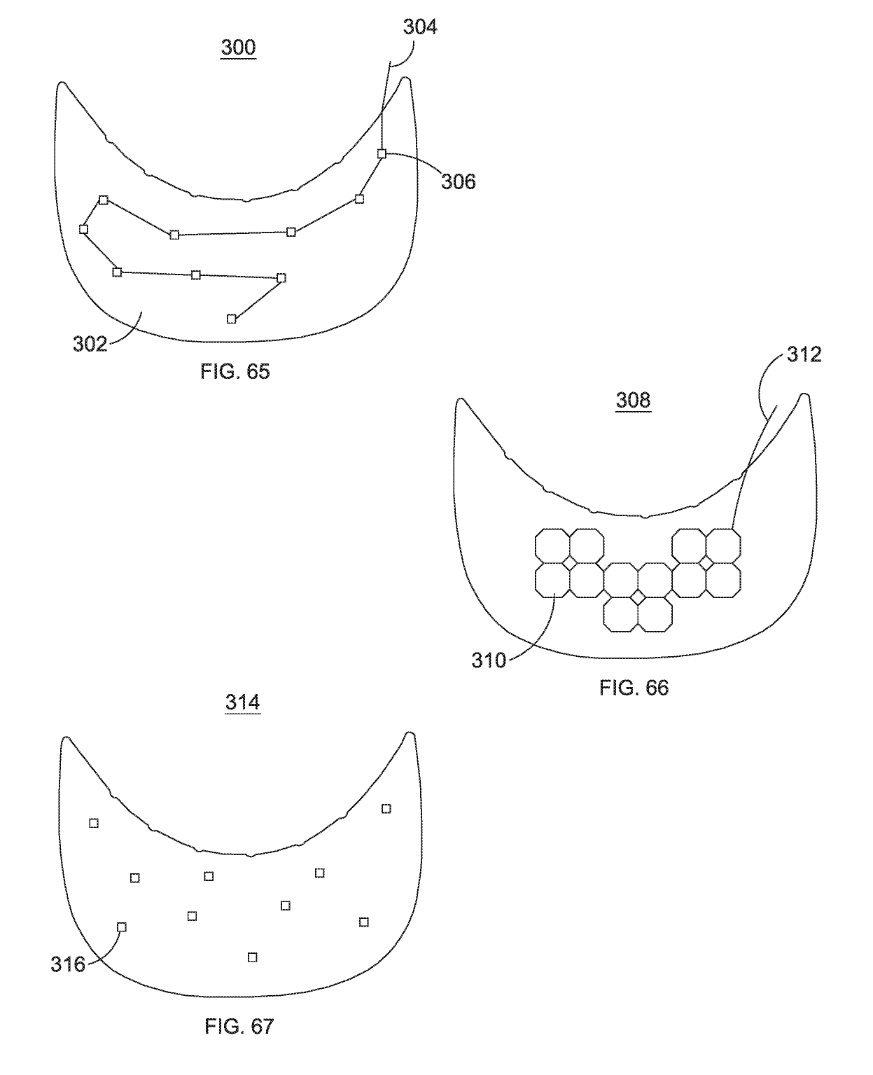

FIG. 65 shows a top view of an alternative plastic cap bill 300 in accordance with an example embodiment. An illumination source 306 and illumination source wiring 304 is placed inside a bill shaped piece of plastic 302 by means during the casting process of the bill shaped piece of plastic 302, by creating a bill shaped piece of plastic with a hollow section, or other means of the like. The illumination source 306 and illumination source wiring 304 may comprise parts from an LED assembly, electroluminescent material, laser powered fiber optic, or other illumination sources of the like.

FIG. 66 shows a top view of an alternative plastic cap bill 308 in accordance with an example embodiment. A solar panel array 310 is placed onto the alternative plastic cap bill 308 to provide a means of capturing solar rays and transmitting power via wires 312 to a power storage device. Alternatively the solar panel array 310 can be mounted anywhere along the exterior of a cap.

FIG. 67 shows a top view of an alternative plastic cap bill 314 in accordance with an example embodiment. Reflective material 316 is placed into the alternative plastic cap bill 314 to provide a means of reflecting lights in multiple directions.

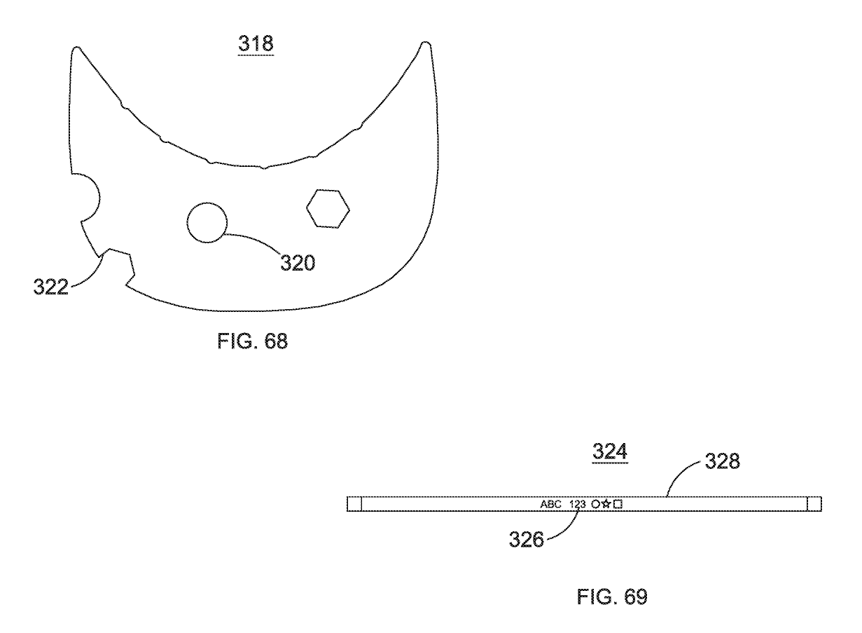

FIG. 68 shows a top view of an alternative plastic cap bill 318 in accordance with an example embodiment. Bill cut outs 320 and bill edge cut outs 322 are constructed in the alternative plastic cap bill 318 to provide an accessible means to a water bottle or flavored beverage opener. Multiple bill cut outs 320 and bill edge cut outs 322 can be provided to fit a wider variety of opening means.

FIG. 69 shows an edge view of an alternative plastic cap bill 324 in accordance with an example embodiment. Bill edge 328 is left clear to provide clear visual means of the projected edge illumination design 326. In some illumination assemblies, the light source is able to provide clear details such as lettering, numbers, and pattern designs. The illumination assembly may consist of a display screen made to the contour of the alternative plastic cap bill 324. The illumination assembly may comprise a flexible active matrix organic light emitting diode (AMOLED) display screen similar to the A3 OLED screens made by Samsung.

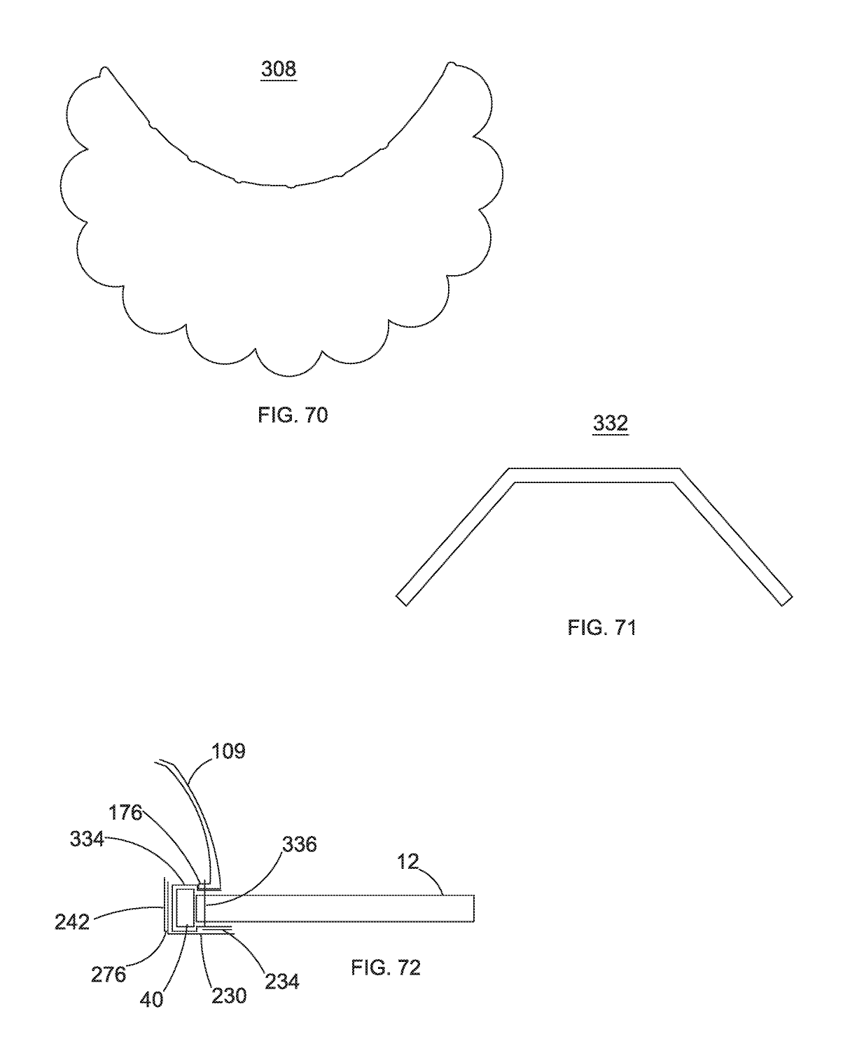

FIG. 70 shows a top view of an alternative plastic cap bill 330 in accordance with an example embodiment. By using a plastic material for the alternative plastic cap bill 330, it is easily feasible to make a cap bill into any desirable shape and not be limited to the conventional cap bill shape.

FIG. 71 shows a front view of an alternative plastic cap bill 332 in accordance with an example embodiment. By using a plastic material for the alternative plastic cap bill 332, it is easily feasible to make a cap bill into any desirable shape and not be limited to the conventional cap bill shape.

FIG. 72 shows a sectional view of the fitted cap crown 109 attached to a plastic cap bill 12 by connections means 336, in accordance with an example embodiment. The interior cap crown fold 176 is penetrated by connection means 336. Connection 334 is used to contain the LED strip 40 and plastic cap bill 12. Connection means 334 helps facilitate the use of connection means 336 to connect the fitted cap crown 109 to connection means 334 and plastic cap bill 12. Connection means 334 may comprise plastic casing, metal casing, or other connection means of the like. Connection means 334 may comprise screws, rivets, plastic connectors, pins, sewing, or other connection means of the like.

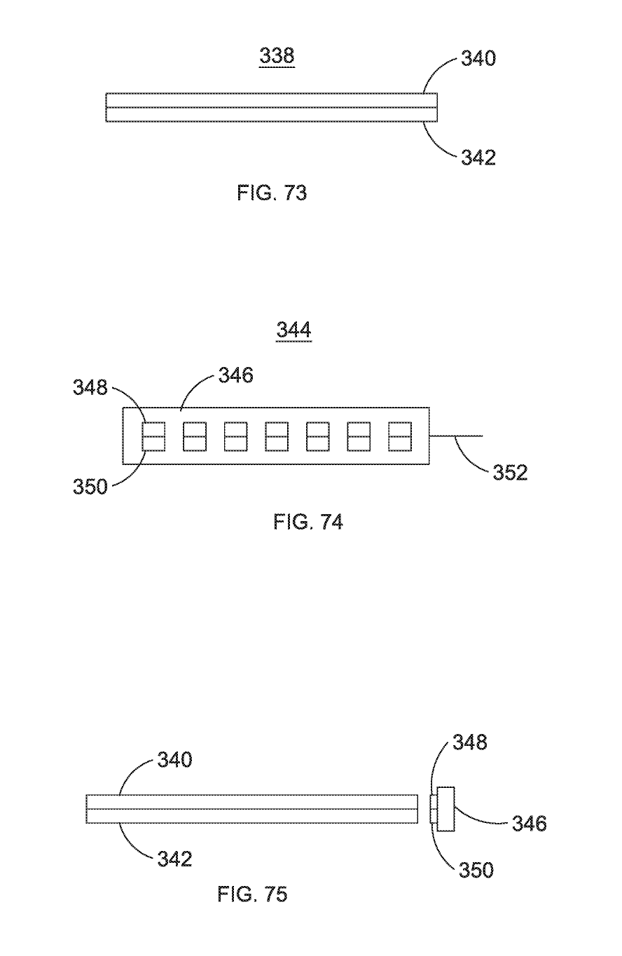

FIG. 73 shows a front view of an alternative plastic cap bill 338 in accordance with an example embodiment. The alternative plastic cap bill 338 comprises of two layers of plastic, the top layer 340 and the bottom layer 242. The benefit of having multiple layers is that each layer creates its own infinite internal reflection, even if both layers of plastic are resting on each other. This means that when light is focused at the edge of the top layer 340, the majority of light only enters the top layer 340 and minimal light enters the bottom layer 342. This also means that if decorative designs were placed on the top layer 340 and bottom layer 342, a user could control which layer, top layer 340 and bottom layer 342, and therefore which design will get illuminated. With this assembly, a user could create animations or a mixture of patterns by controlling which layer, top layer 340 or bottom layer 342, receives edge lighting. Furthermore, if the number of plastic layers were increased, the number of animations and pattern combinations is increased.

FIG. 74 shows a top view of an illumination assembly 344 in accordance with an example embodiment. The illumination assembly 334 comprises a base 346, a top layer of light emitting components 348, a bottom layer of light emitting components 350, and wires 352. The illumination assembly 344 can control the illumination to only be produced by the top layer of light emitting components 348, or bottom layer of light emitting components 350, or both layers. Illumination assembly 344 may comprise of additional layers of light emitting components and different arrangements of light emitting components. Illumination assembly 344 may comprise of similar technology to double row flexible LED strip SUR-5050-FW280-24V from Shenzhen Surmountor Lighting CO, Limited.

FIG. 75 shows a sectional view of the positioning of the top layer 340 and bottom layer 342 from FIG. 73 and the base 346, top layer of light emitting components 348, and bottom layer of light emitting components 350 from FIG. 74 in accordance with an example embodiment. The top layer of light emitting components 348 is positioned next to the top layer 340 so that the top layer 340 receives the majority of light produced by the top layer of light emitting components 348. The bottom layer of light emitting components 350 is positioned next to the bottom layer 342 so that the bottom layer 340 receives the majority of light produced by the bottom layer of light emitting components 348.

The foregoing description of embodiments has been presented for purposes of illustration and description. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

The invention claimed is:

1. An illuminated cap assembly comprising:
an illumination assembly for controlling and powering a light emitting source;
a plastic bill with a first edge surface disposed adjacent to the light emitting source of the illumination assembly, wherein light from the illumination assembly enters the plastic bill, is internally reflected and exits the plastic bill at a second edge or surface;
a cap crown for receiving a person's head; and
connection means for securing the plastic bill and illumination assembly to the cap crown.

2. The illuminated cap assembly of claim 1, wherein the illumination assembly comprises at least one of: an LED assembly, OLED display, electroluminescent material, and laser power assembly.

3. The illuminated cap assembly of claim 1 further comprising one or more control devices comprising at least one of: a switch, a receiver, and a sensor.

4. The illuminated cap assembly of claim 1 wherein one or more LEDs are assembled together in a linear array.

5. The illuminated cap assembly of claim 1 wherein the connection means comprises at least one of: sewing, adhesives, glues, plastic sleeve, plastic locking connectors, pins, hook and loop fasteners, rivets, and screws.

6. The illuminated cap assembly of claim 1 further comprising a wireless receiver within the assembly for receiving wireless signals from outside the assembly that control the operation of the controller circuit.

7. The illuminated cap assembly of claim 6 wherein the wireless receiver receives at least one of: Bluetooth signals, signals from a cell phone to control the controller circuit, IR signals, and RF signals.

8. The illuminated cap assembly of claim 1 wherein the one or more control devices includes command capabilities comprising at least one of: on/off, color control, brightness, and light color pattern.

9. The illuminated cap assembly of claim 1 wherein the power source is a rechargeable battery and further comprising a second electrical connector for connecting the rechargeable battery to an external charging source.

10. The illuminated cap assembly of claim 1, wherein the LED assembly includes a control circuit that is controlled through a sound activation sensor.

11. The illuminated cap assembly of claim 1, wherein the assembly includes a solar panel or solar panels to charge the battery power supply.

12. The illuminated cap assembly of claim 1, wherein the assembly is designed to resist aquatic or high moisture conditions.

13. The illuminated cap assembly of claim 1, wherein the illumination assembly includes a control circuit that can be reprogrammed via computer, cell phone, or smart device.

14. The illuminated cap assembly of claim 1, wherein the plastic bill is plain with no decoration or features.

15. The illuminated cap assembly of claim 1, wherein the plastic bill can be decorated and detailed by at least one of the following: cut-outs, paint, screen printing, etching, CNC routing, stickers, engraving, sanding, markers, cut-outs along plastic bill edge, laser cutting through a fraction of the plastic bill thickness, and cutouts in illumination altering material.

16. The illuminated cap of claim 1, wherein the plastic bill comprises at least one of the following: transparent plastic material, translucent plastic material, polycarbonate, polyethylene terephthalate, and acrylic material.

17. The illuminated cap assembly of claim 1, wherein the illumination assembly is embedded into the plastic bill during the casting of the plastic bill.

18. The illuminated cap assembly of claim 1, wherein the plastic bill is constructed with a hollow cavity to fit the illumination assembly.

19. The illuminated cap assembly of claim 1, wherein the plastic bill contains light reflective material, allowing light to be reflected in multiple directions

20. The illuminated cap assembly of claim 1, wherein the plastic bill is constructed with cutouts that provides the ability to open water bottles and other flavored beverages.

21. The illuminated cap assembly of claim 1, wherein the plastic bill is decorated along the edge of the plastic bill by projecting designs comprising at least of one of: words, numbers, and patterns.

22. The illuminated cap assembly of claim 1, wherein the plastic bill comprises shape retaining plastic

23. The illuminated cap assembly of claim 1, wherein the plastic bill comprises a shape that is not smooth and continuous such as a traditional cap bill shape.

24. The illuminated cap assembly of claim 1, wherein the plastic bill comprises of multiple layers of plastic.

25. A cap assembly comprising;
a photoluminescent bill;
exposure to an environmental light source;
a cap crown for receiving a person's head; and
connection means for securing the photoluminescent bill and to the cap crown.

26. The cap assembly of claim 25, wherein the environmental light source comprises the sun.

27. The cap assembly of claim 25, wherein the environmental light source comprises a black light source.

28. The cap assembly of claim 25, wherein the environmental light source comprises an ultraviolet light.

29. The cap assembly of claim 25, wherein the photoluminescent bill is made of florescent acrylic.

30. An illuminated cap assembly comprising:
an illumination assembly for controlling and powering a light emitting source;
a plastic bill with a first edge surface disposed adjacent to the light emitting source of the illumination assembly, wherein light from the illumination assembly enters the plastic bill, is internally reflected and exits the plastic bill at a second edge or surface;
a cap crown for receiving a person's head;
connection means consisting of adhesive and sewing for securing the plastic bill and illumination assembly and the cap crown.

31. An illuminated cap assembly comprising:
an illumination assembly for controlling and powering a light emitting source;
a plastic bill with a first edge surface disposed adjacent to the light emitting source of the illumination assembly, wherein light from the illumination assembly enters the plastic bill, is internally reflected and exits the plastic bill at a second edge or surface;
a cap crown for receiving a person's head;
connection means consisting of adhesive and sewing and mechanical fasteners for securing the plastic bill and illumination assembly and the cap crown.
